(19) United States
(12) Patent Application Publication
(10) Pub. No.: US 2005/0057512 A1
(43) Pub. Date: Mar. 17, 2005

(54) Browsing based Chinese input method

(76) Inventors: Min-Wen Du, Acton, MA (US); Shih-Chio Chang, Concord, MA (US)

Correspondence Address: Min-Wen Du, 19 Pondview Dr., Acton, MA, 01720, US

(21) Appl. No.: 10/621,216

(22) Filed: Jul. 17, 2003

(51) Int. Cl. G09G 5/00

(52) U.S. Cl. 345/168

(57) ABSTRACT

A platform to implement a Chinese input method consists of the following components: 1. A Keypad. 2. A cascade Multi-Window, 3. A Sentence Editing Buffer. 4. An Attribute Viewing Window. 5. A Text Accumulation Window. 6. A two-level phrase set refining control window. The keypads are designed based on the lexical structures of the Zhu-Yin and Pin-Yin phonetic systems. Efficient mouse operations have been designed to enter phonetic symbol strings. The Multi-Window can present a great many candidate words and phrases. It allows a user to browse on its multi pages without mouse clicking. A two-phase sentence generation procedure relieves users from the burden of sentence segmentation and creates the possibility of harvesting system supplied longer generalized phrases.

### BACKGROUND OF THE INVENTION

1. Field of the Invention

The present invention relates to inputting Chinese text data into a computer.

### RELATED US PATENT DOCUMENTS

U.S. Pat. No. 5,574,482 November 1996, C. J. Niemeier, Method for data Input on a Touch-Sensitive Screen.
U.S. Pat. No. 6,002,390 December 1999, T. Masui, Text Input Device and Method.
U.S. Pat. No. 6,008,799 December 1999, V. Kleeck, Method and System for Entering Data Using Improved On-Screen Keyboard.
U.S. Pat. No. 6,157,371 December 2000, J. P. A. Smeets, Data Processing System Provided with Soft Keyboard that Shifts between Direct and Indirect Character.
U.S. Pat. No. 6,232,969 May 2001, G. S. Fawcett, Device for Composing or Editing a String of Characters.
U.S. Pat. No. 6,271,835 August 2001, H. Hoeksma, Touch-Screen Input Device.
U.S. Pat. No. 6,359,572 March 2002, P. O. Vale, Dynamic Keyboard.
U.S. Pat. No. 6,562,078 May 2003, Yang et. al., Arrangement and Method for Inputting Non-Alphabetic Language.

### OTHER PUBLICATIONS

The Unicode Standard Version 3.0, The Unicode Consortium, Addison-Wesley 1991, Reading, Mass., USA.

### BACKGROUND OF THE ART

Inputting Chinese text data into a computer has been an intriguing problem and is technically very challenging, as evidenced by that thousands of related information items can be found on the Internet by the Google search engine, with the search keys-“Chinese input method”. In many commercial Chinese information front-end products, such as TwinBridge and UnionWay, various input methods have been included in the system to satisfy users' need.

Like in written English or many other western languages, a written Chinese paragraph consists of a string of sentences separated by punctuation symbols, and each Chinese sentence is a string of Chinese words. However, unlike in English, where each word is a string of characters from a small alphabet of size only 26, each Chinese word is a graphical pattern and tens of thousands different patterns are in use.

To input Chinese text into a computer, an encoding scheme is normally required. The scheme can be a hard-coded one, like the 4-digit telegram codes. Other schemes use either the stroke structure or the pronunciation or the mixture of the two of the Chinese words. One may consider the coding symbols of a word in an encoding scheme as an attribute or a signature of the word. To input a sentence, a user specifies the attributes of the words of the sentence. Internally the computer will calculate to find the best match. If there are multi-choices, they are presented to the user to select.

Most early Chinese input methods are word based, in the sense that a user types in the encoding of the words one by one and generate the words one by one. Many recent methods use phrase or context information to improve the accuracy and to speed up the producing of the right sentence words.

In recent years two technologies become more mature and provide new avenues other than a keyboard to input Chinese text data. One is the handwriting recognition technology. Another one is the speech recognition technology. These approaches are basically still a matching process, with the attributes of the words extracted by the computer from the traces of the writing data or the speech sampling data.

Different input methods have their technical advantages and disadvantages based on the technologies it employ. For example, the input speed of a stroke structure based encoding scheme may be very fast once a user becomes proficient of its use. The initial learning curve is normally very steep however because the user needs to learn a non-trivial new skill. An input method using keyboard device is fast and highly accurate because a keyboard is properly designed to be controlled by the fingers of both hands. People ordinarily feel natural to use input methods based on handwriting recognition or speech recognition technologies because they have already learned to speak and write in their younger years and school days. An input method based on handwriting recognition technology is natural to use but it is less accurate than using a keyboard. Writing using a pen is inherently slow, because each Chinese word requires many strokes to write.

Speech recognition is a very promising technology for Chinese text input. To speak is very natural. When people talk in distinct voice and in moderate speed, a moderate recognition rate can be achieved. But in an application domain where a large number of phrases are in use, however, the accuracy rate usually drops sharply. Furthermore, speech recognition technology is very sensitive to the working environment. It is very intrusive to others to be used in a shared office. With a noisy surrounding, the accuracy rate will also drop sharply.

A soft keyboard (or virtual keyboard) is yet another device used to input text data. The idea is to draw a keyboard on the screen so that a user can use the mouse or a pen to activate all events to simulate the real keyboard operations. The advantages of using a soft keyboard are the following. 1. A mouse or a pen is easy to move and click, quiet to operate, and it occupies only one hand. 2. The soft keyboard provides a visual user feedback which makes the operations highly accurate. 3. The soft keyboard can be used without a real keyboard and is suitable to a PDA or a tablet PC working environment.

There are drawbacks in using a soft keyboard to implement an input method, however. The difficulty comes from that a typical implementation of a soft keyboard copies onto the screen the exact layout of a real keyboard, which was designed to allow a user to type blindly using the sense of the relative positions of the fingers. On a soft keyboard, this sense does not apply. A user needs to visually search for the key every time he types a key and it slows down the soft typing. For this reason, a soft keyboard is ordinarily considered as a supplementary tool and is only used casually.

In recent years, soft keyboard with non-conventional layout design have been proposed to enter text into hand-held devices such as a PDA. To avoid confusion, we will refer to a soft keyboard with non-conventional layout design as a soft keypad or keypad. In general, an input method using a keypad requires the following four capabilities to make it suitable to use on a hand-held device:
1. Normally keys are grouped into sections and key panels are shown dynamically in response to user input actions. A reduced number of keys on the screen at any instant is dictated by the small screen size a hand-held device can have. A good side-effect with a reduced number of keys on the screen is that the visual key searching becomes much easier.
2. A proper layout design of each key panel to further ease the key searching task and to facilitate the pointing device operations.
3. A planning of how windows events are activated by the pointing device for a user to enter key information.
4. A procedure to convert a sequence of event signals produced by the pointing device to text data. Word, phrase or sentence candidates are generated for the user to review and select.

Although most of the proposed keypad input methods emphasize their usability on hand-held devices, needless to say that they are also usable on any computer with a pointing device and a larger screen. A text input method for a PDA can be immediately applied on a tablet computer, where a pen is used as the pointing device. Even for a PC or a workstation, a keypad input method will be competitive for text input if the input process can be made efficient and easy to use. Furthermore, by the great flexible capability of graphic user interface design, screen keypads are the ideal glue to integrate various technologies to provide text input service.

To design a keypad for a specific language one needs to address the particular difficulties that language posts and take advantages of the special properties that language possesses. The objective of this invention is to provide a method to perform Chinese text input by specifying word phonetic information. In the following we first describe the chief constituents of this invention and the major issues it deals with. The details of how problems are solved will be described in later sections.
1. Two kinds of keypad have been designed for entering phonetic information into a computer. One is designed for the Zhu-Yin phonetic system and the other one is for Pin-Yin system. The design is based on the lexical structure of the symbol strings of the two phonetic systems. The layout of these keypads and the mouse event handling functionality implemented on them not only enable a user to find a key easily at a glance, but also facilitate the mouse operations to enter phonetic information.
2. A particular problem one has to solve in designing a Chinese input method is how to present a large number of candidate words and phrases. This invention has devised a special window called Multi-Window to deal with this problem. A Multi-Window contains multi window pages so that it can present a large number of words and phrases. The special layout design of the multi pages and the functionality implemented allow a user to browse the contents of the pages without mouse clicking. When a desired word or phrase is found, releasing the mouse button with the cursor on the word or phrase will accomplish the selection task.
3. A Two-Phase Sentence generation Procedure has been devised to input Chinese text data. It has the following main features.
   a. It is frequency-based. System provided phrases are classified into most frequently used, very frequently used, commonly used, and rarely used classes. The design philosophy of “Phrases that are more frequently used should require less effort to find,” has been applied. Leading phonetic symbol strings of the words are used to specify a phrase.
   b. A user iteratively goes through a Key-in phase and an Editing phase to generate sentences. In the Key-in phase, he may key-in words and phrases to compose a sentence. He may also key in phonetic symbol strings in the key-in phase and wait until the editing phase to further reduce the size of candidate words and phrases to do the selection.
   c. Both the Key-in phase and the Editing phase use easy to follow one-way scanning process on a sentence editing buffer. The user is relieved from the burden of segmenting a sentence into component words and phrases. A system may supply a large number of commonly used sequences of words as generalized phrases to speed up user's key-in process. A generalized phrase may be composed from primitive words and phrases. A user can not do the sentence segmentation well in such a system because he doesn't know when to look for a phrase to key in. Therefore, dividing the input process into two phases not only makes the task easier to perform, it has also created a way to harvest system supplied longer generalized phrases.

### SUMMARY OF THE INVENTION

Methods and systems consistent with the present invention, as embodied and broadly described herein, provide a Zhu-Yin (BoPoMoFo) Keypad on the screen to allow a user to enter key codes. The key codes are used by the method or the system to find Chinese words or phrases, and the results are then presented to the user for further examination and selection.

Methods and systems consistent with the present invention, as embodied and broadly described herein, provide a Pin-Yin Keypad on the screen to allow a user to enter key codes. The key codes are used by the method or the system to find Chinese words or phrases, and the results are then presented to the user for further examination and selection.

Methods and systems consistent with the present invention, as embodied and broadly described herein, provide a cascade Multi-Window to present candidate words and phrases to allow a user to browse on the windows and select desired words or phrases.

Methods and systems consistent with the present invention, as embodied and broadly described herein, provide Two-Level Refining Control Windows to allow a user to browse on the control windows to enter phonetic symbol strings by efficient mouse operations.

Methods and systems consistent with the present invention, as embodied and broadly described herein, use a frequency-based scheme to select phrases to present to a user to select. Phrases are classified into four classes: the most frequently used, very frequently used, commonly used, and rarely used. The phrases in each class are presented to the user in different stages to speed up the text input process.

Methods and systems consistent with the present invention, as embodied and broadly described herein, implement a two-phase input procedure to allow a user to enter Chinese text data. The first phase is the key-in phase. The second phase is the refining phase. Both phases use a one-way scanning process on the Sentence Editing Buffer.

Methods and systems consistent with the present invention, as embodied and broadly described herein, implement an architecture where the selected phrases flow from the cascade Multi-Window to the sentence buffer and then to a Text Accumulation Window. Control valves from the cascade Multi-Window, Sentence Editing Buffer, and the Text Accumulation Window to an application program allow the selection of a data flow path from the system to an application.

This summary and the following description of the invention should not restrict the scope of the claimed invention. Both provide examples and explanations to enable others to practice the invention. The accompanying drawings, which form part of the description of the invention, show several embodiments of the invention, and together with the description, explain the principles of the invention.

### BRIEF DESCRIPTION OF THE DRAWINGS

In the Figures:

FIG. 1 illustrates the diagram of the lexical structure tree of the phonetic symbol strings of Zhu-Yin (BoPoMoFo) system in accordance with an embodiment of the invention.

FIG. 2 illustrates the diagram of the lexical structure tree of the phonetic symbol strings of Pin-Yin system in accordance with an embodiment of the invention.

FIG. 3 illustrates the diagram of the system components of the Zhu-Yin phonetic system in accordance with an embodiment of the invention.

FIG. 4 illustrates the diagram of the system components of the Zhu-Yin phonetic system with window overlapping in actual use in accordance with an embodiment of the invention.

FIG. 5 illustrates the diagram of the system components of the Pin-Yin phonetic system in accordance with an embodiment of the invention.

FIG. 6 illustrates the diagram of the system components of the Pin-Yin phonetic system with window overlapping in actual use in accordance with an embodiment of the invention.

FIG. 7 illustrates the control paths and data flow diagram of the system in accordance with an embodiment of the invention.

FIG. 8 illustrates the layout diagram of the Zhu-Yin Keypad in accordance with an embodiment of the invention.

FIG. 9 illustrates the layout diagram of the Pin-Yin Keypad in accordance with an embodiment of the invention.

FIG. 10 illustrates the diagram of the cascade phrase-browsing Multi-Window in accordance with an embodiment of the invention.

FIG. 11 illustrates a table showing the number of phrases that can be fitted into one window page of size equal to 10×10 words of the Multi-Window in accordance with an embodiment of the invention.

FIG. 12 illustrates the diagram of the Sentence Editing Buffer in accordance with an embodiment of the invention.

FIG. 13 illustrates the diagram of the Two-Phase Sentence Generation Procedure in accordance with an embodiment of the invention.

FIG. 14 illustrates the diagram of the Attribute Viewing Window in accordance with an embodiment of the invention.

FIG. 15 illustrates the diagram of the Text Accumulation Window in accordance with an embodiment of the invention.

FIG. 16 illustrates the diagram of the traversing on the lexical structure tree of the Zhu-Yin phonetic system in accordance with an embodiment of the invention.

FIG. 17 illustrates the diagram of the Press-Touch-Release (PTR) operation on the Zhu-Yin Keypad and the R-1 and R-2 refining control window panels in accordance with an embodiment of the invention.

FIG. 18 illustrates the flowchart of the Press-Touch-Release operation on the Zhu-Yin Keypad and the R-1 and R-2 panels in accordance with an embodiment of the invention.

FIG. 19 illustrates the diagram of the traversing on the lexical structure tree of the Pin-Yin phonetic system in accordance with an embodiment of the invention.

FIG. 20 illustrates the diagram of the R-1 refining control window panel of string “D” of Pin-Yin system in accordance with an embodiment of the invention.

FIG. 21 illustrates the diagram of the R-1 refining control window panels of strings “Z” and “ZH” of Pin-Yin system in accordance with an embodiment of the invention.

FIG. 22 illustrates the diagram of the Press-Touch-Release (PTR) operation on the Pin-Yin Keypad and the R-1 and R-2 refining control window panels in accordance with an embodiment of the invention.

FIG. 23 illustrates the flowchart of the Press-Touch-Release operation on the Pin-Yin Keypad and the R-1 and R-2 refining control window panels in accordance with an embodiment of the invention.

FIG. 24 illustrates the diagram of the multi-level frequency-based phrase classification scheme in accordance with an embodiment of the invention.

FIG. 25 is a table showing the number of phrases of the very frequently used phrase set in the Zhu-Yin system that can be presented on one page of the Multi-Window of in accordance with an embodiment of the invention.

FIG. 26 is a table showing the number of phrases of the very frequently used phrase set that can be presented in the Pin-Yin system on one page of the Multi-Window in accordance with an embodiment of the invention.

FIG. 27 illustrates the diagram of the varied-length phrase presentation in the Multi-Window in accordance with an embodiment of the invention.

FIG. 28 illustrates consecutive relation diagrams between the lexical structure tree of Zhu-Yin phonetic symbol strings and the set of all Chinese words in accordance with an embodiment of the invention.

FIG. 29 illustrates an example of the word-by-word key-in process in accordance with an embodiment of the invention.

FIG. 30 illustrates an example of the phrase-by-phrase key-in process in accordance with an embodiment of the invention.

FIG. 31 illustrates the flowchart of the Two-Phase Sentence Generation Procedure in accordance with an embodiment of the invention.

FIG. 32 illustrates an example of the Two-Phase Sentence Generation Procedure in accordance with an embodiment of the invention.

FIG. 33 illustrates the continued example of the Two-Phase Sentence Generation Procedure in accordance with an embodiment of the invention.

### NOTATIONS AND CONVENTIONS

The following notations and conventions will be used in the descriptions of this invention.
1. A Chinese word is a rectangular graphic pattern. Each Chinese word will be assigned a numerical code, its character code or character information.
2. Each Chinese word is associated with a monosyllable pronunciation. Mandarin pronunciation for Chinese words will be used in the examples.
3. The pronunciation of a Chinese word in Mandarin can be represented by a Zhu-Yin (BoPoMoFo) phonetic symbol string followed by a tonal symbol 0 to 4, where 0 represents the light tone, and 1 to 4 represent tone-1 to tone-4.

For example, “ [symbol] ” is pronounced as “ [symbol] ”, and “ [symbol] ” is pronounced as “ [symbol] 4”. The pronunciation of “ [symbol] ” is represented as “ [symbol] 4”.

The Zhu-Yin phonetic symbols will be classified into a consonant set (C-set), a transition vowel set (H-set), and a vowel set (V-set). The following are the lists of the C, H, and V sets.
C-set: { [symbol] [symbol] [symbol] [symbol] }.
H-set: { [symbol] }.
V-set: { [symbol] [symbol] }.

Tonal symbols {0 1 2 3 4} will be referred as the T-set. The T-set can also be represented as { [symbol] }.

A standard Chinese word pronunciation can be represented by a string of four symbols taken from each of the C, H, V, and T sets. For example, “ [symbol] ” is pronounced as “ [symbol] ”. In some cases one or two phonetic symbol components may be missing. For example, “ [symbol] ” is pronounced as “ [symbol] 4” with the vowel component missing.

A blank symbol [symbol] has been added to each of the C, H, and V sets to specify missing components.

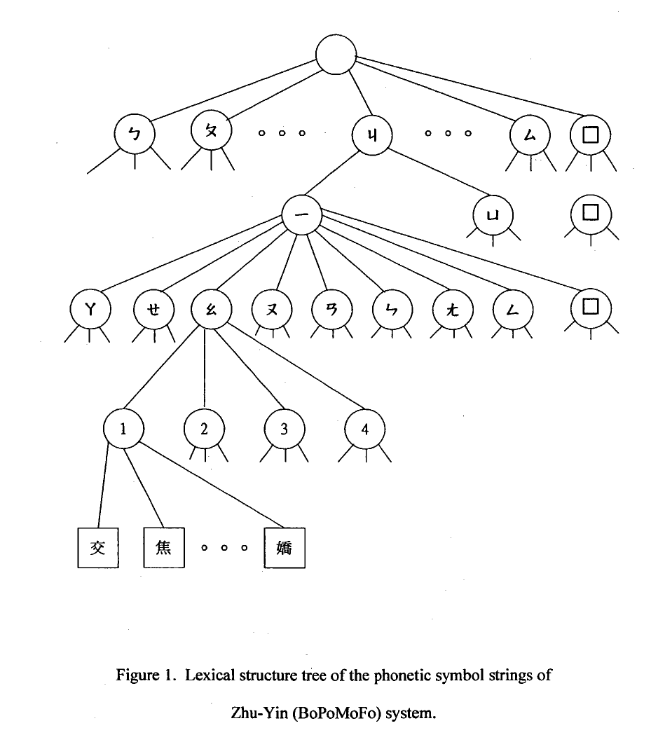

There are about 1400 valid word pronunciations for Mandarin Chinese. Their Zhu-Yin representations can be grouped in the order of C, H, V, and T sequence and organized as a lexical structure tree, as shown in FIG. 1.

FIG. 1 also shows the Chinese words associated with their pronunciation. A Chinese word may be pronounced in different ways. Therefore, the phonetic tree becomes a lattice diagram when the terminal nodes of Chinese words are included.
4. The pronunciation of a Chinese word in Mandarin can also be represented by a Pin-Yin phonetic symbol string consisting of a string of phonetic alphabet symbols of A to Z followed by a tonal symbol 0 to 4.

For example, “ [symbol] ” is pronounced at “ZHUAN1”, and “ [symbol] ” is pronounced as “LI4”. The pronunciation of “ [symbol] [symbol] ” is represented as “ZHUAN1_L14”.

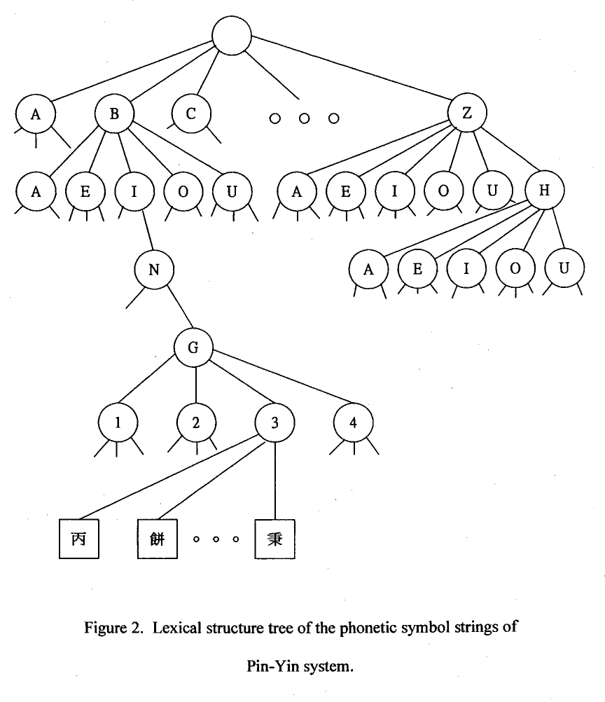

There is a 1-1 mapping between the set of valid Zhu-Yin phonetic symbol string and the set of valid Pin-Yin phonetic symbol string. For example, “ [symbol] ” is mapped to “ZHUAN” and “ [symbol] ” is mapped to “LI”. The Pin-Yin representations can also be organized as a lexical structure tree, as shown in FIG. 2.
5. The character information and the pronunciation information are the two attributes associated with a Chinese word discussed in this invention. When a user selects a phrase displayed on the screen, he essentially enters the character information (the character codes of the words) of the phrase into the computer.
6. A Chinese phrase is a string of Chinese words. A Chinese word can be considered as a Chinese phrase of length one.
7. A Chinese sentence is a linear string composed from Chinese words and phrases. Therefore, a Chinese sentence is also a string of Chinese words. Given a Chinese sentence, there may be more than one way to segment it into meaningful words and phrases. For example, the sentence “ [symbol] ” may be composed from either “ [symbol] ” and “ [symbol] ”, or “ [symbol] ” and “ [symbol] ” segments. Both segmentations form a legitimate sentences, but with different meanings.
8. The notation “cat” denotes the concatenation function to concatenate two strings into one string. For example, cat (AB, C)=ABC, where A, B and C are alphabet symbols. Also, cat (x, w)=xw, where x and w are Chinese words with complete or partial phonetic symbol string information and with or without character information
9. In this invention a mouse is used as the pointing device on the screen. It is understandable that other pointing devices can also be used instead of a mouse.
10. In this invention only one button will be used for mouse operations. The following five mouse operations will be used. a) press the mouse button with the mouse cursor on a key. b) touch the mouse cursor with a key. c) release the mouse button with the mouse cursor on a key. d) click the mouse button with the mouse cursor on a key. e) move the mouse cursor. The click operation is the combination of a press operation followed by a release operation. The first four mouse operations will be also abbreviated as a) press a key. b) touch a key. c) release a key. and d) click a key.

### DETAILED DESCRIPTION

The following description of embodiments of this invention refers to the accompanying drawings. Where appropriate, the same reference numbers in different drawings refer to the same or similar elements.

Methods and systems consistent with the present invention, as embodied and broadly described herein, provide a platform and a method to allow a user to input Chinese text data. The platform and the method can be used either in text generation, or in text editing, or in specifying queries in text retrieval or other application programs.

### Platform Components

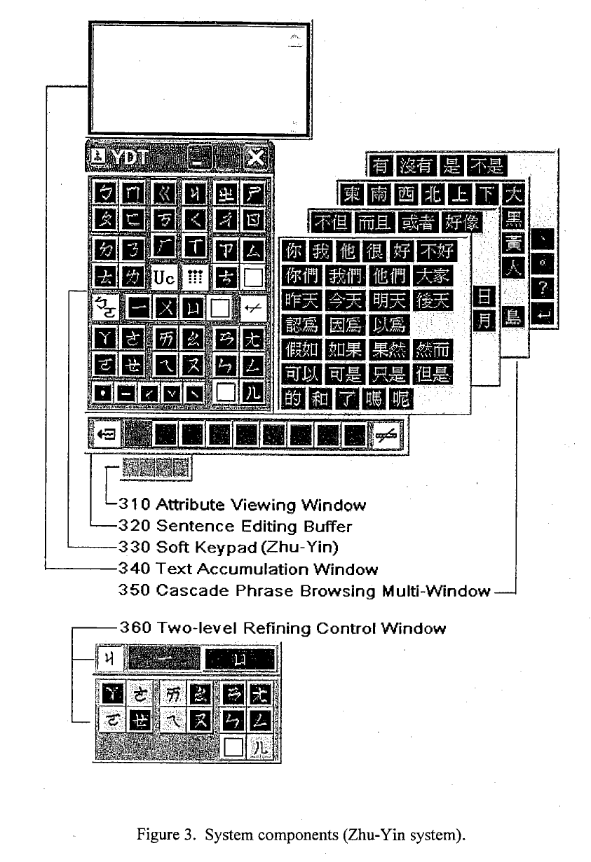

FIG. 3 illustrates a diagram showing the platform components for the Zhu-Yin phonetic system in accordance with an embodiment of the invention. As shown, the platform comprises the following components:
1. A Soft Keypad 330 (Zhu-Yin system).
2. A Cascade Multi-Window 350.
3. A Sentence Editing Buffer 320.
4. An Attribute Viewing Window 310.
5. A Text Accumulation Window 340.
6. A Two-Level Refining Control Window 360 (Zhu-Yin system).

The Soft Keypad is the place where a user keys in phonetic symbol strings of the words of Chinese sentences. A user may also use it to control the selection of phrases. The cascade Multi-Window displays candidate words or phrases on buttons for a user to browse and click to select. The Sentence Editing Buffer displays the sentence that is currently being composed. The Attribute Viewing Window displays the phonetic string of a selected word in the Sentence Editing Buffer. The Text Accumulation Window is the pool to collect sentences generated by the user. The Two-Level Refining Control Window provides the mechanism to allow a user to enter key information through efficient mouse operations.

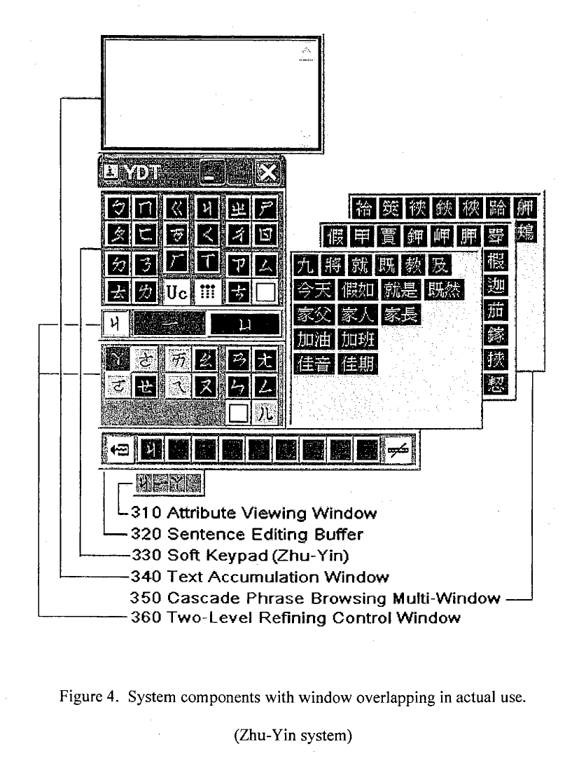

In actual use, the Two-Level Refining Control Window may show on top of the Keypad to save space, as shown in FIG. 4.

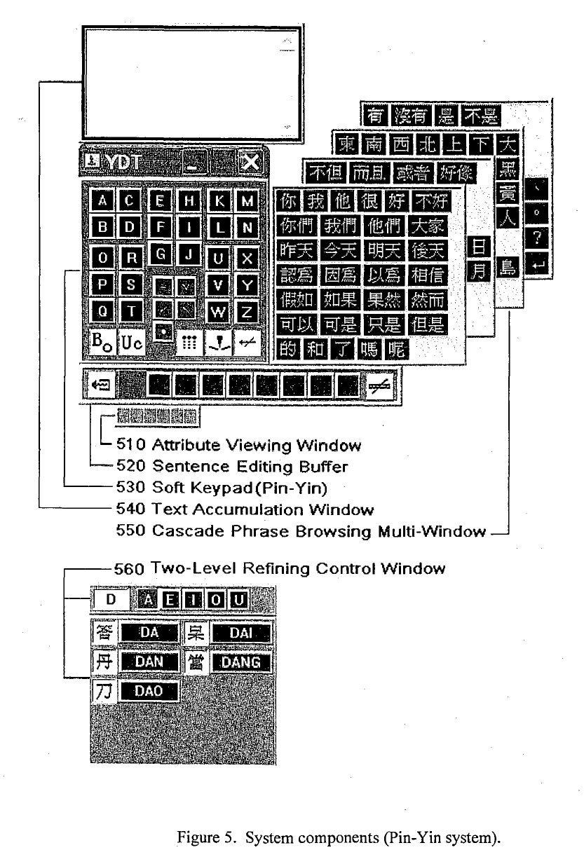

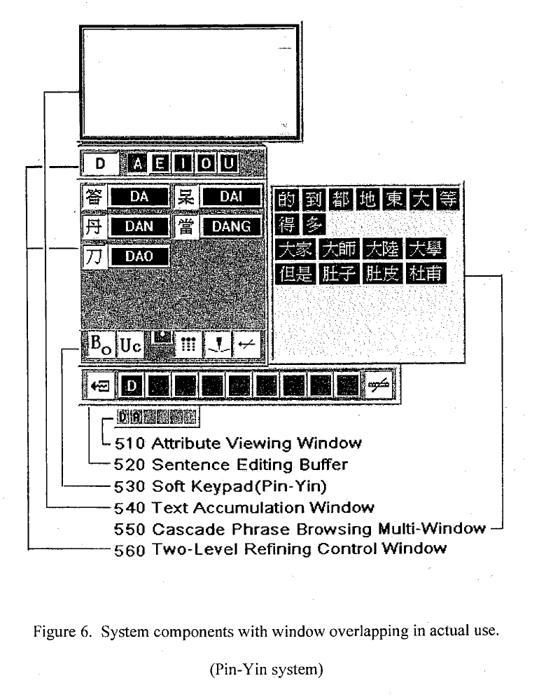

FIG. 5 shows the platform components for the Pin-Yin phonetic system. The Two-Level Refining Control Window may also show on top of the Keypad in actual use, as shown in FIG. 6.

### Control Paths and Data Flow

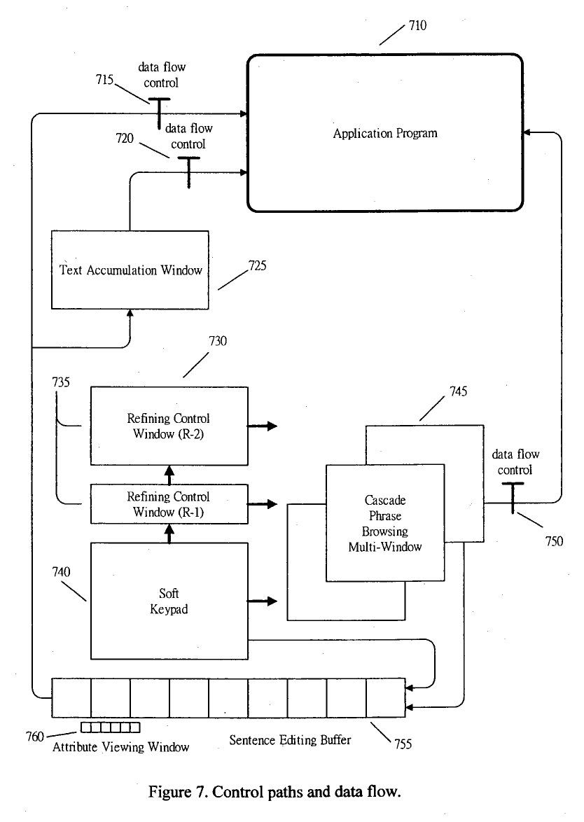

FIG. 7 illustrates the control paths and data flow diagram in accordance with an embodiment of the invention. The user uses the Soft Keypad 740 to key in phonetic symbol strings of the phrases. The system uses this symbol string information to select candidate phrases and present it in the Multi-Window 745. The Two-Level Refining Control Window 735 is used to allow a user to enter phonetic string information efficiently. For the information retrieval point of view, the more phonetic information entered, the more stringent the phrase matching conditions will be. Therefore less candidate phrases will be collected and shown in the Multi-Window.

The user selects words or phrases from the cascade browsing Multi-Window 745. The selected phrase will flow to the Sentence Editing Buffer 755, which is a window with a fixed number of keys to display and manipulate the sentence that is currently being composed. Phonetic symbol strings also flow into the Sentence Editing Buffer 755. When the Sentence Editing Buffer is full, or a punctuation symbol has been entered, the word strings in the buffer will flow to the Text Accumulation Window 725.

There are data flow control valves 715, 720, and 750 that control the data flow from the Cascade Browsing windows, Sentence Editing Buffer, and the Text Accumulation Window to an application program 710. The control valves can be opened and closed by control buttons.

The R-1 Refining Control window panel 731 is controlled by the Soft Keypad 740 in the sense that its content is determined by the phonetic symbol strings entered from the Soft Keypad. Similarly, the R-2 Refining Control window panel 732 is controlled by the R-1 Refining Control window panel 731. The content of the Cascade Multi-Window 745 is changed dynamically according to information keyed in by the mouse operations on the Soft Keypad 740, the R-1 Refining window panel 731, and the R-2 Refining window panel 732.

### Soft Keypad Layout

Zhu-Yin Keypad

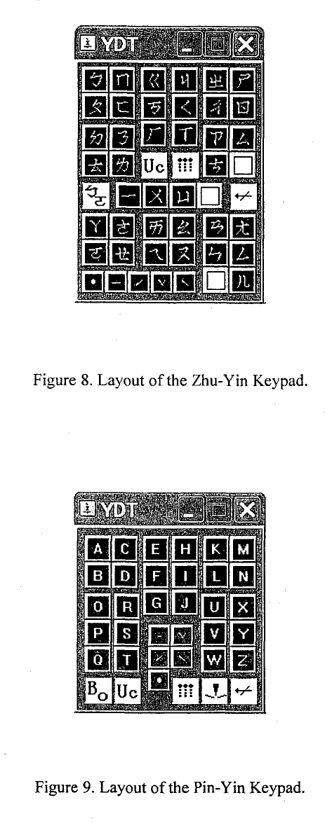

FIG. 8 illustrates the layout diagram of a soft keypad for the Zhu-Yin phonetic system in accordance with an embodiment of the invention. The keypad contains 37 phonetic symbol keys, from “ [symbol] ” to “ [symbol] ”, five tonal keys, three blank keys [symbol] for the C, H, and V sets, and several function keys.

The keypad design is based on the following considerations:
1. Unlike a conventional keyboard, the keypad does not contain punctuation keys. They are moved to a page in the phrase-browsing Multi-Window. With this separation, the number of keys has been much reduced.
2. The phonetic symbol keys and tonal keys are grouped in to C, H, V, and T sections and placed consecutively from top to bottom on the keypad. This arrangement not only helps the key searching process, it also facilitates the mouse operations, as to be described in later sections.
3. The 22 C-set keys are gathered into six groups as [ [symbol] , [symbol] , [symbol] , [symbol] , [symbol] , [symbol] ]. The six groups are arranged from top to bottom and from left to right in the C section area.
4. The 4H-set keys [ [symbol] ] are arranged in a row and placed between the C section and the V section to facilitate mouse operations.
5. The 14 V-set keys are gathered into three groups as [ [symbol] , [symbol] , [symbol] ]. The three groups are arranged from left to right in the V section area.
6. The 5 T-set keys [ [symbol] ] are arranged in a row and placed below the V section to facilitate mouse operations.
7. The keys within each group of the C, H, V, and T sections are arranged in the standard Zhu-Yin symbol order inside the group. Spaces have been reserved between neighboring groups.

The partitions of the keys into sections and groups, the order of groups within each section, and the order of keys within each group provide a user with a simple sense of the locations of the keys. This sense, together with that the number of keys has been much reduced; enable a user to find a key on the keypad at a glance.

Pin-Yin Keypad

FIG. 9 illustrates the layout diagram of a soft keypad for the Pin-Yin phonetic system in accordance with an embodiment of the invention. The keypad contains 26 alphabet keys, from A to Z, five tonal keys, and several function keys.

The keypad design is based on the following considerations:
1. Unlike a conventional keyboard, the keypad does not contain punctuation keys. They are moved to a page in the phrase-browsing Multi-Window. With this separation, the number of keys has been much reduced.
2. The 26 alphabet keys are gathered into eight groups as [ABCD, EFG, HIJ, KLMN, OPQ, RST, UVW, XYZ].
3. The eight groups in consideration 2 above are arranged in the alphabetical order and placed from left to right, top to bottom onto the keypad with spaces between neighboring groups.
4. The keys in each group are arranged in alphabetical order inside the group. Spaces have been reserved between neighboring groups

The grouping of keys, the order of groups on the Keypad, and the sequence order of keys within each group provide a user with a simple sense of locations of the keys. This sense, together with that the number of keys is much reduced, enable a user to find a key on the keypad at a glance.

Function Keys

The function keys used in this system are described below. Details of some of their functions will be further explained in later sections.
1. [symbol] : The key to indicate that the current keypad is using Zhu-Yin system. When clicked, the keypad will be changed to Pin-Yin mode.
2. [symbol] : The key to indicate that the current keypad is using Pin-Yin system. When clicked, the keypad will be changed to Zhu-Yin mode.
3. [symbol] : This button indicates that the text exported from the system will be in Unicode codes. When clicked, the text exported will change to use other coding schemes.
4. [symbol] : This is a button to select between the Automatic-Firing and the Manual-Control key-in mode.
5. [symbol] : This is a button used to end the typing of the Pin-Yin phonetic symbol string of the current word when the system is using Pin-Yin phonetic system and in Manual-Control key-in mode.
6. [symbol] : This is a simple editing button to erase the phonetic symbol string of the current word.
7. [symbol] : When clicked, the text content in the Sentence Editing Buffer will flow to the Text Accumulation Window.
8. [symbol] : A button used to delete all the information in the Sentence Editing Buffer.

### Cascade Multi-Window

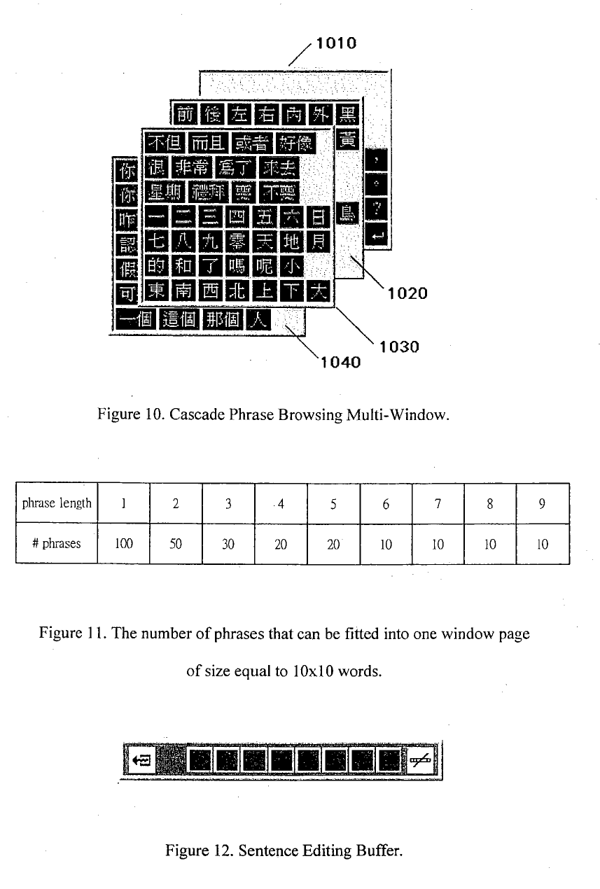

FIG. 10 illustrates the diagram of a Multi-Window 1010 designed to present a set of words and phrases to the user. The user can use the mouse to browse words and phrases in the multi pages of the Multi-Window, and, with a mouse button click, to select a word or a phrase if a desired one is found. A user can move the mouse cursor onto and off a button in the windows. The multi pages can be browsed without mouse clicking operations. The word or phrase selection operation will be triggered by a mouse button-up event.

When using a Chinese input method to generate text data, often a set of phrases would need to be presented to the user for selection. A traditional design is to present the phrase candidates in a small one-dimensional window. Assuming that a one-dimensional window can fit 10 candidate phrases, the system will first present 10 candidate phrases. If the user cannot find the desired phrase among the first 10, he needs to use a control button to get the next 10 for examination, and so on so forth. This process becomes very tedious and hard to use when there are a large number of candidates to examine.

A two-dimension window is sometimes used for phrase presentation in existing systems. In this design, phrases are fitted row by row into a rectangular window. If the user cannot find the desired phrase in the window, he can use a control button to load the next group of candidates into the window for examination. Ordinarily the width of a two-dimensional window is much smaller than that of a one-dimensional window to avoid blocking the application program. Therefore, extra mouse clicking operations are still required to find a phrase.

The phrase searching task can be made much more efficient and easier by the cascade windows 1010 shown in FIG. 10. A Multi-Window has the following properties:
1. A Multi-Window comprises several rectangular windows (window pages). The window pages are of the same size.
2. The window pages are arranged in a cascade form, going from a lower-left position to a higher-right position on the screen.
3. At any time one of the window pages in the Multi-Window is the topmost window on the screen.
4. Every window page in the Multi-Window has an exposed region on the screen. Window pages lower than the topmost window page show an L-shaped region on the screen. Window pages higher than the topmost window page show an inversed L-shaped region on the screen. These L-shaped and inversed L-shaped regions surround the topmost window page layer by layer. This relationship will be maintained anytime a window page is brought to the top of the Multi-Window.
5. When the mouse cursor is moved onto the exposed region of a window page in the Multi-Window, that window page will be brought to the top. This allows a user to browse the pages of the Multi-Window sequentially along either the ascending direction or descending direction of the cascade without any mouse clicking.
6. The window pages in the Multi-Window may contain buttons to display Chinese words, phrases and punctuation symbols. A user may browse among the buttons of these window pages and select a word, a phrase, or a punctuation symbol with a mouse button-up action.
7. A word, a phrase, or a punctuation symbol selected from a window page in the Multi-Window will flow to the Sentence Editing Buffer, and be appended at the end of the sentence that is currently being composed in the Sentence Editing Buffer. The selection will also flow to an application program if the valve between the Multi-Window and the application program is open.

This design of the Multi-Window has the following advantages.

1. The Multi-Window extends the traditional one-dimension or two-dimension windows for phrase presentation to three-dimensional; in the sense that it contains two-dimension windows and it also has a third dimension, the depth. This makes it capable of presenting a great number of candidates. Assuming that each window page of the Multi-Window is of size 10 (words) by 10 (words), and that phrases are fitted into the page from left to right, and then from top to bottom without wrapping around in the phrases, FIG. 11 shows the number of phrases that can be fitted into one page of the Multi-Window. For example, to fit into a page with phrases of length 3, each row can fit with 3 phrases. Therefore 10 rows can fit with 30 phrases.

2. At any time the window page at the front is surrounded by an L-shaped and an inversed L-shaped exposed portions of its neighboring pages. When the mouse cursor moves across these L-shaped or inversed L-shaped regions, the windows underneath will be brought to the front. This provides an easy way to browse the window pages sequentially in both the ascending direction and descending direction of the cascade, with only the mouse move operation.

3. Every window page that is not at the front has an L-shaped or inversed L-shaped exposed portion seen by the user. This gives the user a sense of what is contained in a covered page.

### Sentence Editing Buffer

FIG. 12 shows the Sentence Editing Buffer. Any Chinese sentence is a string of words and phrases. A user usually keys in words and phrases to compose a sentence. In the input method of this invention a user can key in a word or a phrase by either explicitly selecting a word or phrase from the Multi-Window, or he can key in the leading phonetic symbol string of the words and wait until getting into the editing phrase of a two-phase input procedure to select the right words and phrases. In the former case, the Chinese character information of the word or phrase is selected and thus has been uniquely determined. In the later case, the Chinese characters of a phrase may have several choices. Best guessing may be used to select a phrase to serve as a temporary placeholder. The user can find the desired phrase to replace the temporary one in a later editing phase.

When the words within a sentence are selected and determined, they are shown on the tops of the keys of the Sentence Editing Buffer. In case the phonetic symbol string is not enough to make a good guessing, the first phonetic symbol of each word will be shown on top of the keys.

For example, the phonetic symbol strings of “ [symbol] ” is “SHEN1_QING3_ZHUAN1_LI4”. If “ [symbol] ” is entered as a phrase selected from the Multi-Window, and “ [symbol] [symbol] ” is keyed in as a series of phonetic symbol strings “ZH LI”, the character string “ [symbol] ” will be shown in the Sentence Editing Buffer, where “Z” and “L” are temporarily used to represent the two words “ [symbol] ” and “ [symbol] ”.

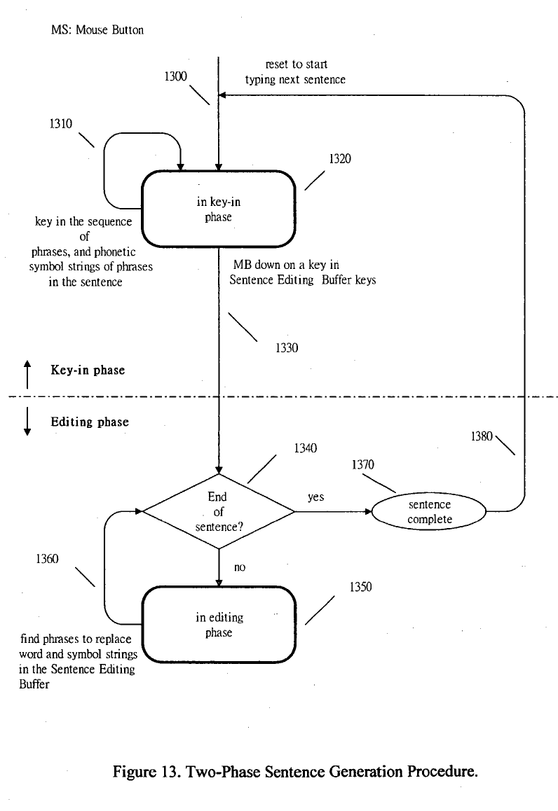

FIG. 13 shows the flowchart of the Two-Phase Sentence Generation Procedure. At the beginning 1300 the sentence is reset to an empty string. The method enters the key-in phase. The user iteratively keys in phrases or phonetic symbol strings to compose the sentence with the system staying in the key-in phase 1320. At the end of the key-in phase for the current sentence, the user presses the mouse button down with the cursor on a key in the Sentence Editing Buffer to enter the editing phase 1350. In this phase, the system will iteratively scan the Sentence Editing Buffer from left to right 1360 to find the words where the character information has not yet been designated. The user can resume the phonetic information entering process to reduce the number of candidates and select a word or a phrase from the Multi-Window to replace those undesignated words. When the current sentence is completed 1370, the process will return 1380 to the key-in phase 1320 for the next sentence.

### Attribute Viewing Window

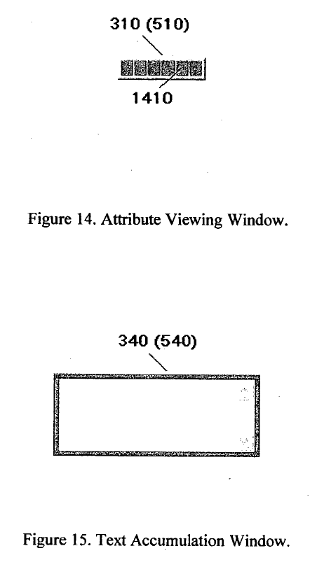

FIG. 14 shows the Attribute Viewing Window. Here the attribute of a word is the phonetic symbol string and the tonal symbol of the word. When the mouse cursor is placed over a key in the Sentence Editing Buffer, the Attribute Viewing Window will show the phonetic symbol string information currently available for the word of that key.

### Text Accumulation Window

FIG. 15 illustrates the Text Accumulation Window. It is a text edit control. When the Sentence Editing Buffer is full, or when a punctuation symbol is entered, the current sentence under composition will flow to this window. The Text Accumulation Window is served as a larger intermediate buffer between the system and an application program.

### Key-In Modes

The input method of this invention distinguishes two types of key-in modes—Manual-Control Key-in mode and Automatic-Firing key-in mode. These key-in mode are selected by the [symbol] function button.

Manual-Control Key-In Mode

1. Zhu-Yin System:

In the Manual-Control key-in mode, the user manually selects the word of current focusing by clicking the mouse on the keys in the Sentence Editing Buffer. He will have full control of selecting the C, H, V, and T components of the word of focusing. He can select and de-select the phonetic symbols by clicking the keys in the C, H, V, and T sections.

2. Pin-Yin System:

In the Manual-Control key-in mode, the user continuously key-in the phonetic symbol string of a word by clicking the phonetic keys and tonal keys in the keypad. The system will automatically advance to the next word only at the end of a phonetic symbol string that is not the leading string of other valid phonetic symbol strings. For example, after the user entered “BIN”, the system will not advance to the next word because “BIN” is the leading string of another valid phonetic symbol string “BING”. After the user keyed in “BING”, however, the system will advance to the next word because it does not subsume any other valid phonetic symbol strings. The user can use the [symbol] function button to interrupt the keying of the current string and advance to the next word.

Automatic-Firing Key-In Mode

In the Automatic-Firing key-in mode, the user will use a specially designed sequence of mouse operations called PTR operation to enter the phonetic symbol string of a word, where PTR represents the sequence of three mouse operations 1) press a first key. 2) touch a second key. 3) release on a third key. At the end of a PTR operation, the system will automatically advance to the next word in the Sentence Editing Buffer and wait for the user's next PTR mouse operation. In all the discussions that follow, the system will be set in Automatic-Firing Key-in mode.

A special case of the Automatic-Firing mode is called the Rapid-Firing mode in which the user only enters the first phonetic symbol of each word of a sentence during the key-in phase of the Two-Phrase Sentence Generation Procedure.

### Mouse Operations on ZHU-YIN Keypad

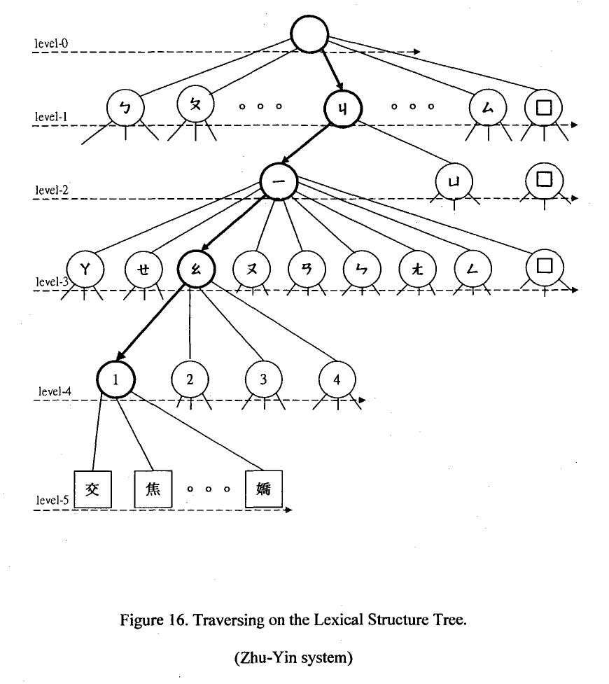

The input method of this invention allows a user to key-in either the complete phonetic symbol string representation of a word, or a partial heading string of the complete string. By entering a phonetic symbol string of a word into the system, a user actually specifies the phonetic components of the pronunciation of that word, which in turn constrain the set of valid candidate words to choose. For example, as shown in FIG. 16, assume that the complete phonetic symbol string “ [symbol] 1” has been entered, the set of possible Chinese words are { [symbol] , [symbol] , . . . , [symbol] }. However, if only “ [symbol] [symbol] [symbol] ”has been specified, the set of possible Chinese words will be those words that have its C, H, and V components matched with the symbols “ [symbol] ”, “ [symbol] ”, and “ [symbol] ” respectively. That set is all the Chinese words contained in the sub-tree of the branch of “ [symbol] [symbol] [symbol] ”, shown in FIG. 16.

FIG. 16 shows six levels of depth of specification. Level-0 is the unconstrained level. Level-1 to 4 correspond to the C, H, V, and T component levels. Level-5 corresponds to the Chinese word level. At that level, the specific Chinese word is selected.

Press-Touch-Release (PTR) Mouse Operation

A Press-Touch-Release (PTR) sequence of mouse operations has been designed to allow a user to efficiently select the C, H, and V phonetic components of a Chinese word. A standard PTR sequence consists of the following mouse operations. 1. Press a consonant key to select the consonant symbol. 2. Move the cursor to touch a transition vowel key to select a transition vowel symbol. 3. Release the mouse on a vowel key to select a vowel symbol.

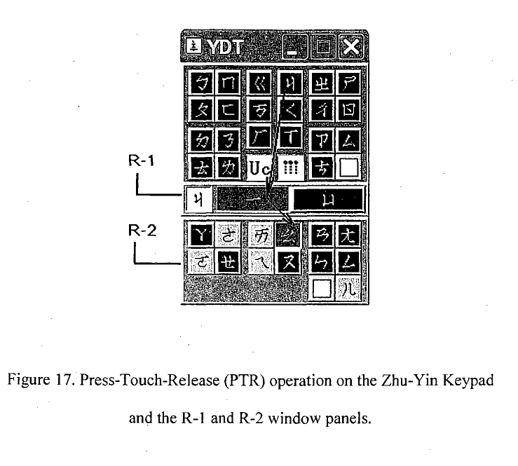

For example, to select phonetic symbols “ [symbol] ”, “ [symbol] ”, and “ [symbol] ” (FIG. 17), a user can perform the following PTR operations. 1. Presses the key “ [symbol] ” in the keypad. 2. Moves mouse cursor to touch the key “ [symbol] ” to select. 3. Moves the cursor to the key “ [symbol] ” and releases the mouse button for its selection. Conceptually, a PTR operation traverses on level-1 to level-3 on a lexical structure tree (FIG. 16) to specify the C, H and V phonetic components of a word.

A user can specify only the leading portion of a phonetic string by releasing the mouse button on keys in the C section or the H section. For example, if the user presses the key “ [symbol] ”, then touches “ [symbol] ”, and then releases the mouse button, he has effectively entered the string “ [symbol] [symbol] ”, which is the leading string of “ [symbol] [symbol] [symbol] ”.

Some pronunciations may have the C or H components missing. In those cases, an implication rule is useful to fill in blanks. For example, if the user at the beginning of a PTR operation presses the key “ [symbol] ”, which is a symbol in the H-set, the C component must be a blank. Similarly, if the user presses the key “ [symbol] ” at the beginning of a PTR operation, which is a symbol in the V-set, both the C and V components must be blanks.

The grouping and the placement of the phonetic keys on the keypad (FIG. 3) has been designed to facilitate the PTR operations. The C, H, and V sections have been placed from top to bottom on the Keypad with the H section lying between C and V sections so that the PTR operation can go starting from the C section, penetrating the H section then ending at the V section, just like writing an ordinary stroke. The keys in the H section are arranged in a row to enable the selection by touching operation. When the mouse cursor moves from the C section to the V section, one key in the H section will be selected.

The system provides the following two further helps to make the PTR operation even simpler.
1. Once a symbol in the C set has been selected, the set of possible symbols of H component that can follow can be determined. In the lexical structure diagram these possible symbols are the descendent nodes of the node corresponding to the selected C symbol. In general, this set of descendant nodes is a reduced H set. For example, if “ [symbol] ” is selected as the C component, only “ [symbol] ” or “ [symbol] ” can be the H component. The system will extend the two keys of “ [symbol] ” and “ [symbol] ” to span the whole H section and hide other keys in the H section. A label of the C symbol is also added to the H section. This dynamically created H section will be called an R-1 refining control window panel, as shown in FIG. 17, where the label “ [symbol] ” is added to the control window panel.
2. Similarly, once the symbol in H set has been selected, the set of possible symbols of V component that can follow can be determined. For example, if “ [symbol] ” and “ [symbol] ” have been selected as the C and H components, the set of symbols that can follow is { [symbol] [symbol] }. At this stage, the system will disable those invalid keys in the V section. This dynamically created V section will be called an R-2 refining window panel, also show in FIG. 17.

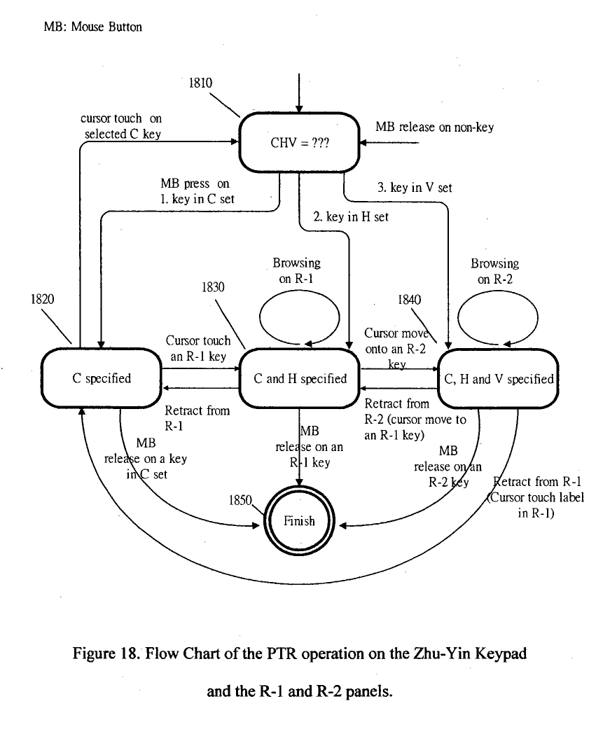

The PTR operation can be made completely retractable at selecting the C, H, and V components of the pronunciation of a word, as shown in the flow chart of FIG. 18. When the mouse cursor moves among the keys in R-1, the selection of H components is changing dynamically, together with the corresponding R-2 window panel. When the cursor moves onto the label in R-1, the H component is de-selected. If the mouse button is released with the cursor not on any key in the system, all C, H, and V components will be de-selected.

When the mouse button is released on a valid C or H or V key, one PTR operation is finished. At that instant, the R-1 and R-2 will disappear and the Keypad will be reset to its original state.

Entering a Tonal Symbol

After a PTR operation, if the user desires, he can select a tonal symbol by touching the cursor with the tonal key (FIG. 3). The five tonal keys are also arranged in a row to facilitate the key touching operation.

Entering a Chinese Word

The cascade Multi-Window will also show matched Chinese word candidates of the current focusing in the Sentence Editing Buffer if the C, H, and V components entered for the word of focusing form a valid phonetic symbol string. The user can move the mouse cursor to the Multi-Window and press on one of the candidate word. He effectively selects the Chinese word. The Multi-Window will recalculate to show only phrases that also match with this selected Chinese word. With the mouse button still down, the user can browse the new set of phrase candidates and release the button on a desired phrase to select it.

### Mouse Operations on Pin-Yin Keypad

Mouse operations on the Pin-Yin Keypad can be designed similar to that for Zhu-Yin system although the lexical structures of the two systems are somewhat different (FIG. 1 and FIG. 2). Different R-1 and R-2 panels are constructed for the Pin-Yin system to cope with the differences, as described in the following paragraphs.

String Partition

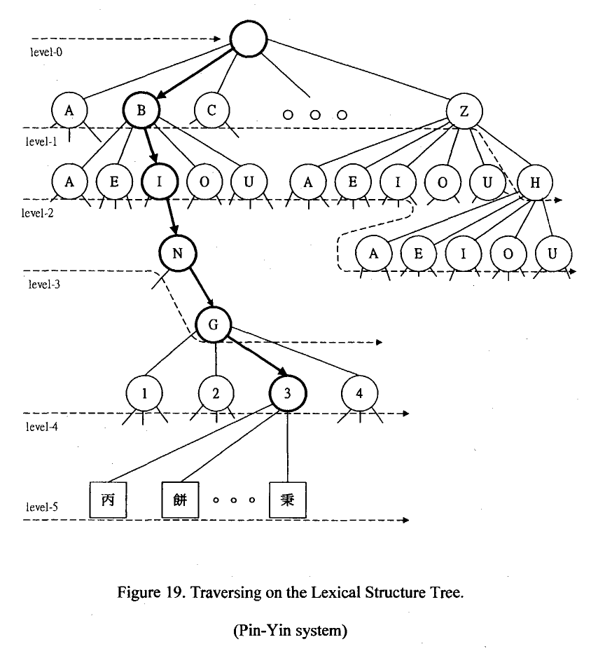

There is a 1-1 correspondence between the set of the phonetic symbol string in Pin-Yin system and that of the Zhu-Yin system. To implement the PTR operation for the Pin-Yin system, we partition every Pin-Yin phonetic symbol string into three segments—first string (ζ), second string (a), and third (tail) string (T). They are described below.
1. First string (ζ): {A, B, C, CH, D, E, F, G, H, JI, JU, K, L, M, N, 0, P, QI, QU, R, S, SH, T, W, XI, XU, Y, Z, ZH} is the set of the first strings chosen.
2. Second string (σ): The set of symbols of the descendant nodes of the node of a first string on the lexical structure tree (FIG. 19) is chosen as the set of the second strings for that first string.

For example, the set of descendants of the first string “B” is {A, E, I, 0, U}, indicating that one of the symbol of {A, E, I, 0, U} may follow the string “B” in a phonetic symbol string in the Pin-Yin system. Therefore, {A, E, I, 0, U} is the set of the second strings of “B”.

An exception to the above rule is that if symbol “a” is a first string, and string “ab” is also a first string, then symbol “b” is excluded from the set of second strings of string “a”. For example, since both “Z” and “ZH” are first strings, “H” is excluded from the set of the second strings of “Z”. Therefore, the set of the second strings of “Z” is {A, E, I, O, U} (FIG. 19).

With the proper choosing of the first strings in statement 1, most first strings have {A, E, I, O, U} as its set of the second strings. In case the fist string itself is already a valid phonetic string, a blank symbol will be added to the set of the second strings. For example, “JU” can be followed by one of the symbol of {A, E, N}. Since “JU” itself is also a valid phonetic string, the set of the second strings of “JU” is {A, E, N, □}.

The maximum size of the set of the second strings of a first string in the Pin-Yin system is 6.
3. Third string (T): Given a first string and a second string, the set of its third strings is the set of all the remaining tail portion of valid phonetic symbol strings that beginning with the given first string and second string.

For example, the three strings that can follow the first string “JI” and the second string “A” are “NG”, “AN”, and “AO”. “JIA” itself is also a valid string. Therefore, the set of the third strings for “JI” and “A” is {NG, AN, AO, □}, where □ represents a blank third string.

The maximum size of the set of the third strings is 9 in the Pin-Yin system.

Press-Touch-Release (PTR) Mouse Operation

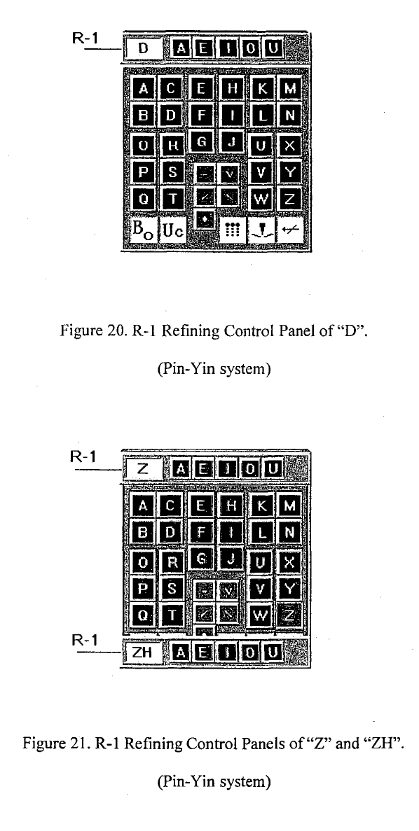

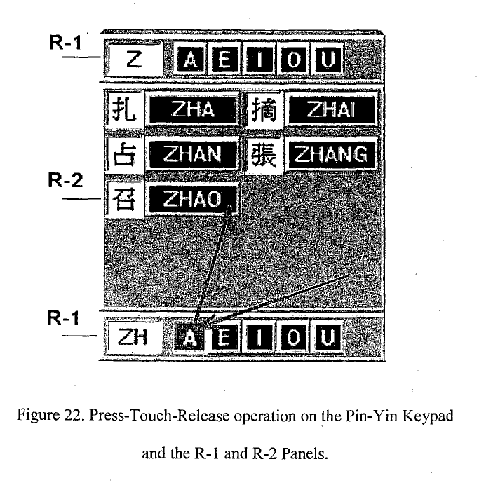

A user can also apply the Press-Touch-Release (PTR) sequence of mouse operations on the Pin-Yin keypad. A standard PTR sequence consists of the following mouse operations.
1. Press an alphabet key in {A to Z}. A corresponding R-1 refining control panel containing the second strings will pop up on the screen. For example, if the user presses on “D”, the R-1 refining control panel of “D” containing keys {A, E, I, O, U} will pop up on the screen (FIG. 20). In cases where two first strings having the same leading alphabet symbol, such as the {Z, ZH} case, two R-1 control panels will pop up, with one showing at the top and another showing at the bottom of the keypad (FIG. 21).
2. Move the cursor to touch a key in R-1 to select the second string a. An R-2 refining control panel will pop up containing the tail phonetic strings. For example, if the user presses on “Z”, then move the cursor to touch key “A” in the R-1 panel of “ZH”, an R-2 panel will pop up, containing tail strings {□, N, O, I, NG} (FIG. 22). A candidate in an R-2 panel will show the complete phonetic symbol string with the ζ, σ, and τ component strings together with a label of representative Chinese word to make recognition easy. In FIG. 22, five complete phonetic strings are shown in R-2 as {ZHA, ZHAI, ZHAN, ZHANG, ZHAO}.
3. Move the cursor onto a key in R-2 and release the mouse button. For example, in FIG. 22, the user moves the cursor onto the key labeled as “ZHAO” and releases the mouse button. The alphabet symbol string entered is “ZHAO”.

Conceptually, a PTR operation also traverses on the lexical structure tree of the Pin-Yin system (FIG. 19) to specify the ζ, σ and τ component strings of a word pronunciation. Any time when the user releases the mouse button with the cursor on a valid key in the Keypad and the R-1 and R-2 panels, a string of alphabet symbols is entered which can be either a complete or a heading phonetic symbol string of a word.

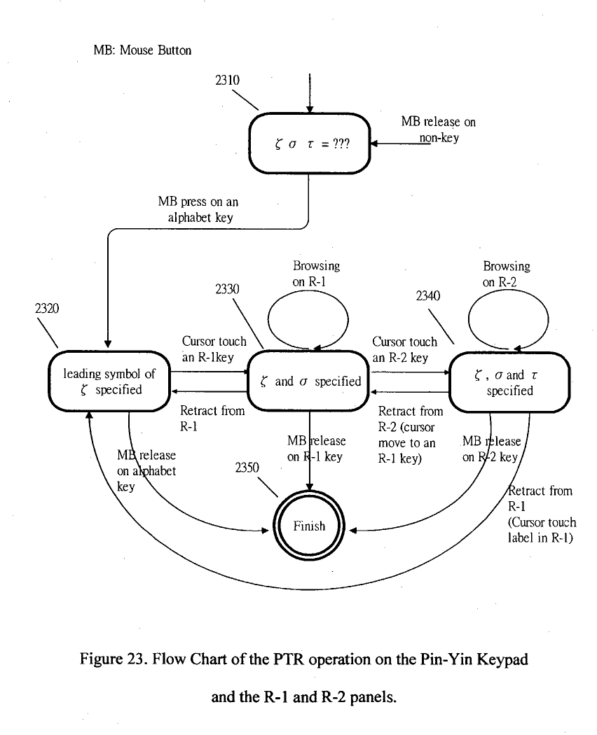

As with the Zhu-Yin case, the PTR operation can also be made completely retractable at selecting the heading symbol of ζ, and selecting σ, and τ strings, as shown by the flow chart in FIG. 23.

A Frequency-Based Phrase Classification Strategy

Phrases that match the phonetic information keyed in by a user are collected from the system phrase tables. They are presented in the Multi-Window for the user to browse and select. This is done in both the text key-in phase and the editing phase of the Two-Phase Sentence Generation Procedure.

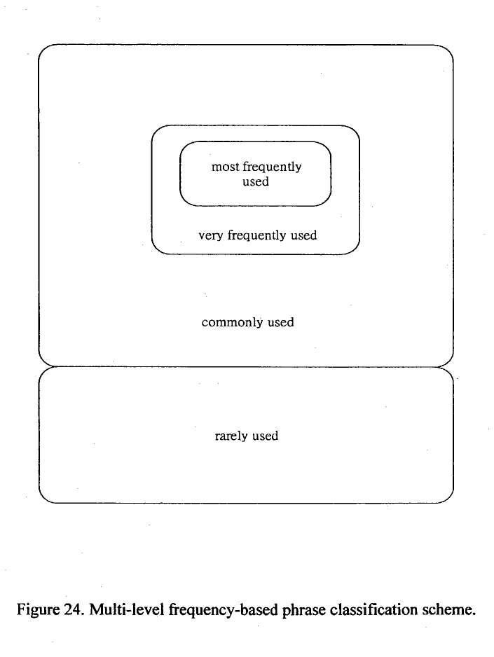

A frequency-based classification strategy is utilized in the design of the phrase selection. FIG. 24 shows the levels of the classification. The phrases are classified into most frequently used, very frequently used, commonly used, and rarely used classes. The most frequently used set is contained in the very frequently used set, while the very frequently used set is contained in the commonly used set. Rarely used phrases are not shown to the user until the user explicitly clicks a control button. Only at that moment, the rarely used words and phrases are included in the phrases presentation.

The most frequently used phrase set is the default phrase set to be displayed in the Multi-Window. The very frequently used phrases are classified according to the first symbol of the phonetic symbol string of the first word of the phrases. When the user moves the mouse cursor over a key on the Keypad, the subset of the very frequently used phrases associated with that key will be shown in the Multi-Window. The user can move the cursor on the Keypad to preview the very frequently used phrases associated with each key. When he sees the desired phrase set, he needs to press that key, to hold the current phrase set in the Multi-Window. He can then moves the cursor to the Multi-Window for browsing and selection.

For example, assume that the system is now in the Key-In mode. When the user moves the mouse cursor over the key “ [symbol] ”, all the very frequently used phrases that are associated with “ [symbol] ” will be shown in the Multi-Window. When the user moves the mouse cursor off key “ [symbol] ”, he will see the default most frequently used phrases in the Multi-Window again.

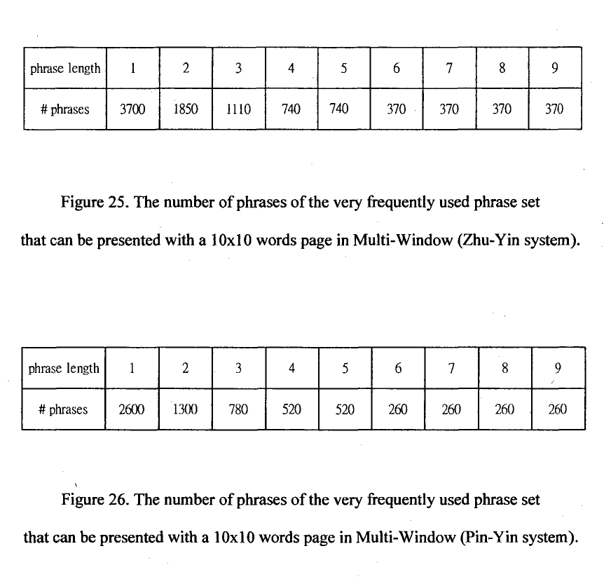

FIG. 11 shows also the number of the most frequently used phrases that can be displayed in one page of the Multi-Window. FIG. 25 shows the total number of very frequently used phrases that can be displayed on a 10×10 page in the Multi-Window in Zhu-Yin system, as allowed by using the 37 phonetic keys to differentiate key associations. FIG. 26 shows the number of the most frequently used phrases that can be displayed in a 10×10 page of the Multi-Window in Pin-Yin system, as allowed by using the 26 phonetic keys.

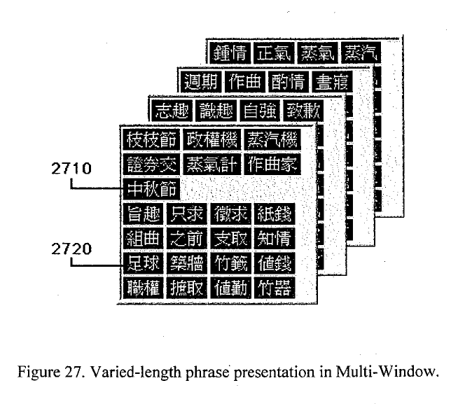

When the phonetic information of more than one word has been entered, normally a few pages of the Multi-Window will be sufficient to display all the matched commonly used phrases, even in the natural Chinese text writing application domain. The more information entered, the smaller will be the matched phrase set. The Multi-Window is designed to display longer phrases first, followed by shorter ones. This is because that a longer matched phrase will have a better chance to be the one that the user desires. FIG. 27 shows the Multi-Window containing commonly used phrases that match with the three C components “ [symbol] ”, “ [symbol] ”, and “ [symbol] ” of the words of a phrase. For example, the Zhu-Yin phonetic symbol strings of the phrase “ [symbol] ” 2710 is “ [symbol] [symbol] ”. It matches with the three C component symbols “ [symbol] ”. On the other hand, the Zhu-Yin phonetic symbol strings of the phrase “ [symbol] ” 2720 is “ [symbol] ”. It also matches with the first two symbols “ [symbol] ”. Both of these two phrases are shown in the cascade Multi-Window of FIG. 27.

The design philosophy of “Phrases that are more frequently used should require less effort to find,” has been applied here. The most-frequently used phrases are the default phrase set so that a user can go directly to the Multi-Window to find them without any mouse operations on the Keypad. He needs to browse and press a key on the Keypad, and then goes to the Multi-Window for a very frequently used phrase. To enter a phrase beyond the most frequently used and very frequently used, the user needs to key in the phonetic symbol strings of more than one word.

### Two-Phase Sentence Generation Procedure

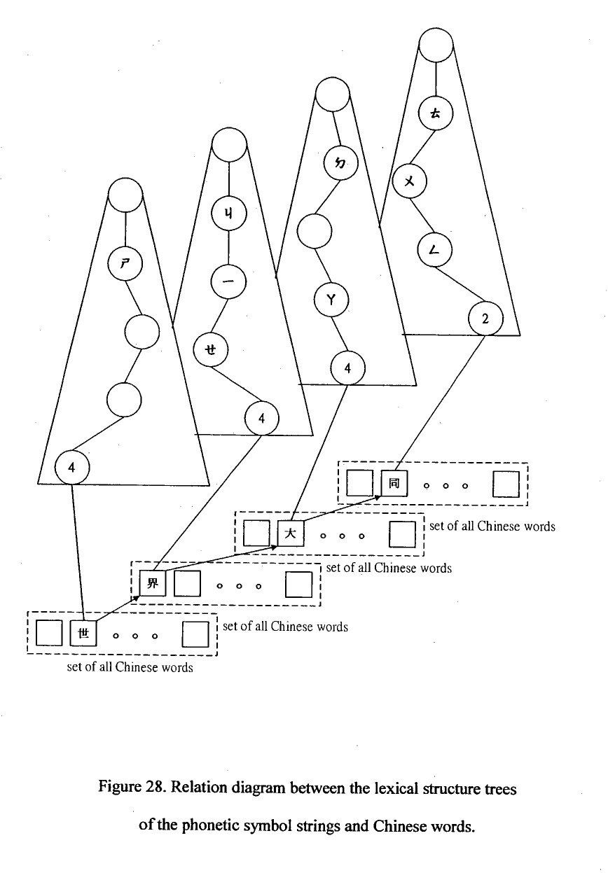

This invention provides a flexible text key-in procedure to allow a user to key in Chinese text data by words, by phrases, or by sentences. This text key-in process will be described by referring to a diagram (FIG. 28) that shows consecutive relation plains of a sentence. Each relation plain shows the relation between a lexical structure tree and the set of all Chinese words. A specific valid sentence “ [symbol] [symbol] ” has been shown in FIG. 28. Here we assume that “ [symbol] ” and “ [symbol] ” are two phrases provided in the system phrase table but not “ [symbol] [symbol] ”.

Key in a Word by Phonetic Information

Here we show how to key in a Chinese word by specifying its phonetic symbol string.

The system will always have a focus word in the Sentence Editing Buffer in the text generating process. During the key-in phase, the focus word is the last word of the current sentence being composed in the Sentence Editing Buffer. During the editing phase, the focus word is determined by the user where he intends to resume the phonetic information entering task.

The system will show Chinese word candidates at the focusing point once and only when the phonetic symbol string entered at the focus word location represents a valid phonetic symbol string. For example, if “ [symbol] ” is the string entered, the Multi-Window will not show any words corresponding to this string because “ [symbol] ” is not a valid phonetic symbol string. On the other hand, if “ [symbol] ” is the string that has been entered, the Multi-Window will show the set of all words that pronounced as “ [symbol] ” with any tone, but not any word with an additional vowel, such as “ [symbol] ” of “ [symbol] [symbol] ”.

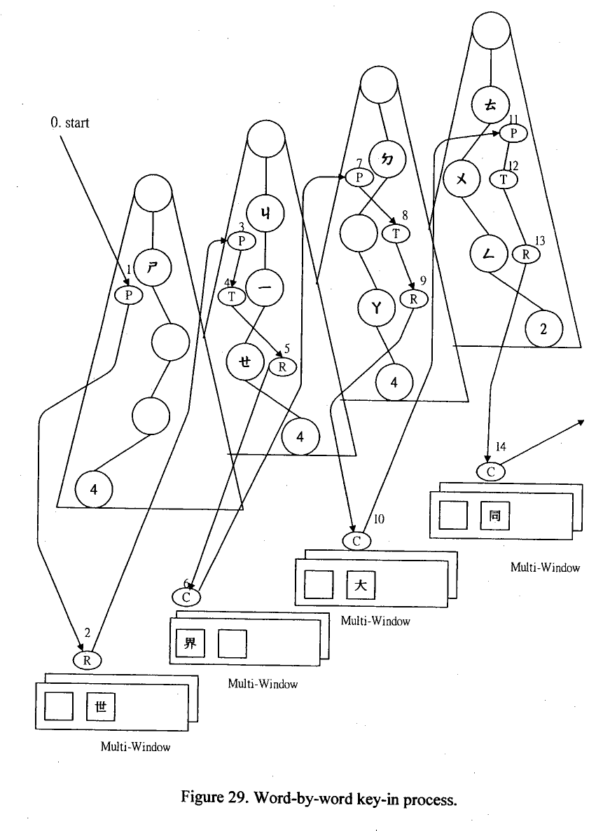

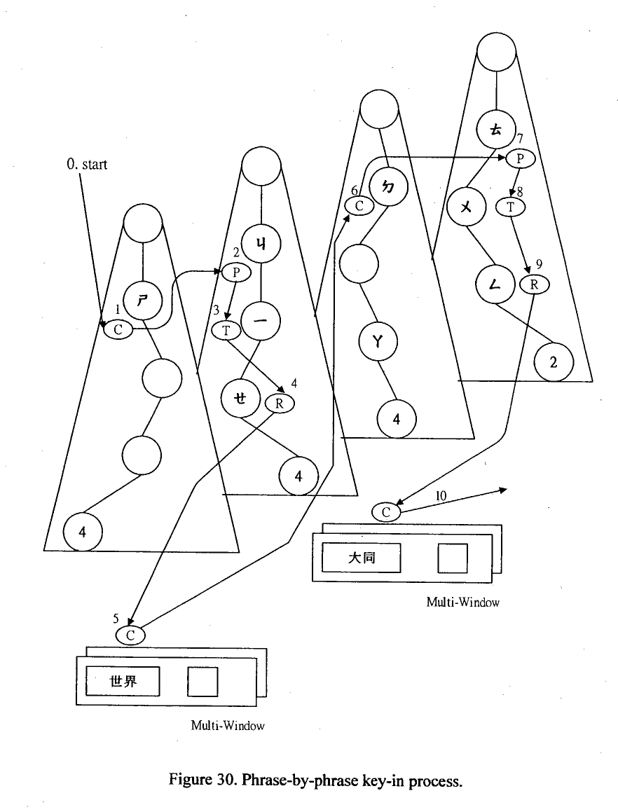

“ [symbol] ” can be keyed in word-by-word in the steps shown in FIG. 29, where small ellipses represent mouse press, cursor touch, release, and click (press then release) operations, labeled as p, t, r and c respectively. The lines between small ellipses represent mouse cursor move operations.

For example, the user uses the following steps in FIG. 29 to enter the Chinese word “ [symbol] ”.
Step 3. Press on key “ [symbol] ”.
Step 4. Move cursor to touch key “ [symbol] ”.
Step 5. Release button on key “ [symbol] ”. The Keypad will be reset to its original state at this point, and all the words having phonetic symbol string as “ [symbol] [symbol] ” will show in the Multi-Window.
Step 6. Move the cursor to the Multi-Window and click on the word “ [symbol] ” to select.
   Key in a Phrase by Phonetic Information

FIG. 30 shows the steps to key in the phrases “ [symbol] ” and “ [symbol] ” to compose the sentence “ [symbol] [symbol] ” by specifying its phonetic symbol strings. Again a PTR operation is used to specify a leading phonetic symbol string for each word in the sentence.

For example, the user uses the steps including the following in FIG. 30 to enter the Chinese phrase “ [symbol] ”
Step 6. Click on key “ [symbol] ”.
Step 7. Press on key “ [symbol] ”. The phrase “ [symbol] ” appears in the Multi-Window, with quite many other candidates. The user decides to key in more information to constrain the phrase selection.
Step 8. Touch on key “ [symbol] ”. The phrase “ [symbol] ” is still in the Multi-Window, but the number of phrase candidates has been reduced than in Step 7.
Step 9. Release the mouse on key “ [symbol] ”. At this point, the phrase “ [symbol] ” is still in the Multi-Window, but now the number of phrase candidates is much reduced.
Step 10. Move the cursor to the Multi-Window and click on the phrase “ [symbol] ” to select.

Comparing FIG. 29 with FIG. 30, we can observe that to key in a sentence phrase-by-phrase requires less mouse operations than to key in the sentence word-by-word. This is generally true because that in a practical application, the set of phrases is ordinarily very sparsely populated in the domain of all possible combinations of the pronunciations. The longer the phrase, the sparser the distribution will be. Therefore, it is not necessary to use all the phonetic components of a phrase to reduce the set of candidate phrases to a workable size.

Key in Sentence-by-Sentence

Since every Chinese sentence is a string of words and phrases, a person who is proficient in either Zhu-Yin phonetic system or Pin-Yin phonetic system should be able to key in words and phrases to compose sentences by specifying its phonetic information. In the process, he may still encounter the following two problems:
1. How much phonetic information of each word should be keyed in to get a desired phrase? One actually encounters the following dilemma: The more phonetic information entered, which requires more keying effort, the smaller will be the set of candidate phrases, which requires less effort to find the desired phrase. The reverse is also true.
2. When is the appropriate time to look for a phrase in the Multi-Window? This problem is related to how to segment a sentence into words and phrases and knowing what phrases have been provided in the system.

For example, assume that the system phrase table contains all the three phrases “ [symbol] ”, “ [symbol] ”, and “ [symbol] [symbol] ”, and that the user wants to key in a sentence containing the word string “ [symbol] [symbol] ”. If the user starts looking for the phrase “ [symbol] ” after he keyed in the phonetic information for the two word “ [symbol] ” and “ [symbol] ”, he will miss the opportunity that less information is needed to key in to get the combined phrase “ [symbol] [symbol] ”.

The Two-Phase Sentence Generation Procedure is designed in this invention to deal with the above two problems. A user will iteratively go through a Key-in phase and an Editing phase to generate sentences. In the Key-in phase, the user sequentially keys in Chinese words, phrases to compose the sentence. The words and phrases may be selected from the most frequently used and very frequently used sets. Leading strings of valid phonetic symbol strings can be entered as placeholders for those words. In the Editing phase, PTR operations can be resumed on words where Chinese character information has not been designated yet.

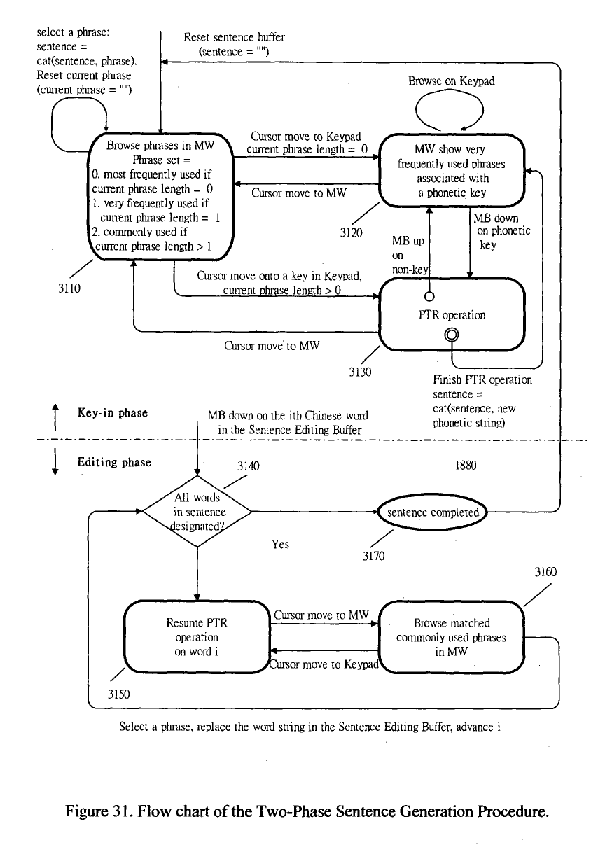

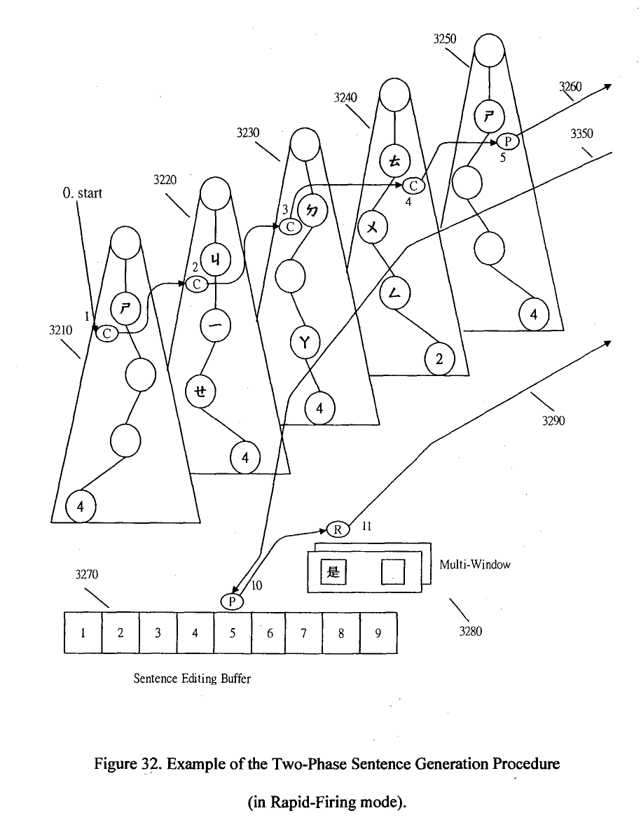

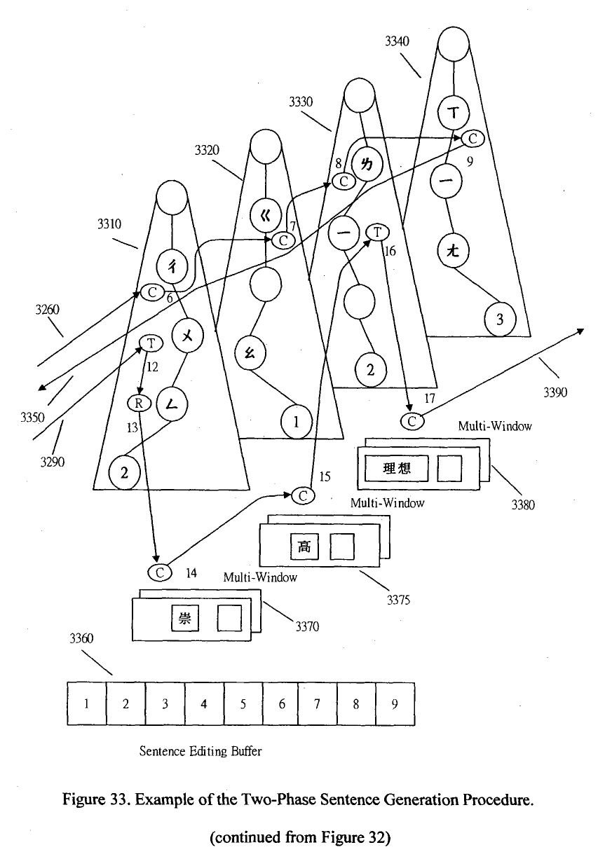

FIG. 31 shows the flowchart of this Two-Phase Sentence Generation Procedure. An example (FIG. 32, FIG. 33) will be used to describe the using of this procedure to generate the sentence “ [symbol] [symbol] ”. In the example the following assumptions are made for the purpose of showing various input situations.
1. The system provides: most frequently used word “ [symbol] ”; very frequently used word “ [symbol] ”; commonly used phrases “ [symbol] ”, “ [symbol] ” and “ [symbol] ”; all the words in the sentence are also commonly used words.
2. The user knows that: “ [symbol] ” is a most frequently used word; “ [symbol] ” is a very frequently used word; “ [symbol] ” and “ [symbol] ” are commonly used phrases; all the words in the sentence are also commonly used words.

Rapid-Firing key-in strategy will be used in the example, i.e., the user will click to key in the first phonetic symbol of each word of the sentence in the key-in phase.

Explanation of Each Step in FIG. 32 and FIG. 33:

Step 1. Click on “ [symbol] ” in the Keypad (Cursor move to keypad first).
Step 2. Click on “ [symbol] ”
Step 3. Click on “ [symbol] ”
Step 4. Click on “ [symbol] ”
Step 5. Click on “ [symbol] ”
Step 6. Click on “ [symbol] ”
Step 7. Click on “ [symbol] ”
Step 8. Click on “ [symbol] ”
Step 9. Click on “ [symbol] ”.

Steps 1 to 9 apply the Rapid-Firing key-in strategy and specify the first phonetic symbol of each word in the sentence. It repeatedly go through the loop of 3130 and 3120 in FIG. 31.
Step 10. Click on the key #5 in the Sentence Editing Buffer.

Here it is assumed that “ [symbol] ” has been shown on keys #1 to #4 in the Sentence Editing Buffer and it is the unique longest phrase matches with the sequence of heading strings “ [symbol] [symbol] [symbol] ”. This action tells the system that the words in the entries #1 to #4 are already the desired ones, and the PTR operation can resume at word 5.
Step 11. Since “ [symbol] ” is a mostly used word, it is already in the Multi-Window. Move the cursor to the Multi-Window and click on “ [symbol] ” to select. The focus location will be advanced automatically by the system to #6 in the Sentence Editing Buffer.
Step 12. Resume the PTR operation on the #6 word. Touch on “ [symbol] ”.
Step 13. Release on “ [symbol] ”.
Step 14. “ [symbol] ” is a valid phonetic symbol string. “ [symbol] ” will be shown in the Multi-Window. Move the cursor to the Multi-Window and click on “ [symbol] ” to select. The focus location will be advanced automatically to #7.
Step 15. Since “ [symbol] ” is a very frequently used word associated with “ [symbol] ” which has been entered for word #6, it is shown in the Multi-Window. Click on “ [symbol] ” to select. The focus location will be advanced automatically to #8.
Step 16. “ [symbol] ” is a commonly used phrase that matches with the sequence of heading strings “ [symbol] ”. There are also quite many other candidates that matches with the sequence “ [symbol] ”. Resume the PTR operation for word 8 by touching “ [symbol] ” to provide more phonetic information to reduce the number of phrase candidates.
Step 17. The phrase “ [symbol] ” has been spotted after step 16. Move the cursor to the Multi-Window to click on it and select. The generation of the sentence “ [symbol] [symbol] ” has been completed.
   Properties of the Two-Phase Sentence Generating Procedure

In the following we summarize the properties of the Two-Phase Sentence Generation Procedure.

1. The keypads and key panels are designed based on the lexical structure of the symbol strings of the Zhu-Yin and Pin-Yin phonetic systems. The design allows easy key locating and efficient mouse operation for entering phonetic information.

2. A specially designed window called Multi-Window with multi window pages is used for candidate words or phrases presentation. The multi pages can present a great many words and phrases. The special layout design of the multi pages and the functionality implemented allows a user to browse the pages sequentially in both the ascending and descending direction without mouse clicking operations.

3. A five-step refinement scheme is designed to allow a user to adaptively refine his specification of a word by phonetic symbol string (FIG. 16 and FIG. 19). An easy to perform sequence of mouse operation, called PTR operation, has been designed to allow a user to specify the phonetic symbol string of a word. The PTR operations are fully retractable. Similar schemes have been designed for both the Zhu-Yin system and the Pin-Yin system to perform PTR operations.

4. The Two-Phase Sentence Generation Procedure is frequency-based. System provided phrases are classified into most frequently used, very frequently used, commonly used, and rarely used classes. The design philosophy of “Phrases that are more frequently used should require less effort to find,” has been applied.

5. A user iteratively goes through a Key-in phase and an Editing phase to generate sentences. In the Key-in phase, he may key in words and phrases to compose a sentence. He may also key in phonetic symbol strings in the key-in phase and wait until the editing phase to further reduce the size of candidate words and phrases to perform the selection.

6. Both the Key-in phase and the Editing phase use easy to follow one-way scanning process on the Sentence Editing Buffer.

7. Dividing the input process into two phases relieves a user from the burden of segmenting a sentence into component words and phrases. It has also created a way to harvest system supplied longer generalized phrases.

### Concluding Remarks

While it has been illustrated and described what are present considered to be preferred embodiments and methods of the present invention, it will be understood by those skilled in the art that various changes and modifications may be made, and equivalents may be substituted for elements thereof without departing from the true scope of the invention.

Although Chinese language and the Zhu-Yin and the Pin-Yin phonetic systems have been used in the discussions, it will be understood by those skilled in the art that the techniques of the present invention can also be applied to languages other than Chinese language and phonetic systems other than the Zhu-Yin and the Pin-Yin systems. It is intended that this invention not be limited to Chinese language and the Zhu-Yin and the Pin-Yin systems.

In addition, many modifications may be made to adapt a particular element, technique or implementation to the teachings of the present invention without departing from the central scope of the invention. Therefore, it is intended that this invention not be limited to the particular embodiments and methods disclosed herein, but that the invention include all embodiments falling within the scope of the appended claims.

1. A Zhu-Yin input method to input Zhu-Yin phonetic symbol string into a computer, said method consists of a Zhu-Yin Keypad, an R-1 refining control window panel, and an R-2 refining control window panel. A sequence of mouse operations called Press-Touch-Release (PTR) operation is designed on the Zhu-Yin Keyboard and the R-1 and R-2 panels to enter valid phonetic symbol strings of the Zhu-Yin system.

2. The method of claim 1, wherein said Zhu-Yin Keypad contains the following keys: 22 C-set keys of the 21 consonant keys “ [symbol] ” to “ [symbol] ” plus a blank key [symbol] , the 4H-set keys of the 3 transition vowel keys { [symbol] } plus a blank key [symbol] , the 14 V-set keys of the vowel keys “ [symbol] ” to “ [symbol] ” plus a blank key [symbol] , five T-set keys of the tonal keys { [symbol] }, and several function keys. The phonetic symbol keys and tonal keys are grouped in to C, H, V, and T sections and placed consecutively from top to bottom on the keypad. The keys are further grouped and arranged as follows.
a. The 22 C-set keys are gathered into six groups as [ [symbol] , [symbol] , [symbol] , [symbol] , [symbol] , [symbol] ]. The six groups are arranged from top to bottom and from left to right in the C section area.
b. The 4H-set keys [ [symbol] ] are arranged in a row and placed between the C section and the V section to facilitate mouse operations.
c. The 14 V-set keys are gathered into three groups as [ [symbol] , [symbol] , [symbol] ]. The three groups are arranged from left to right in the V section area.
d. The 5 T-setkeys [ [symbol] ] are arranged in a row and placed below the V section to facilitate mouse operations.
e. The keys within each group of the C, H, V, and T sections are arranged in the standard Zhu-Yin symbol order inside the group. Spaces have been reserved between neighboring groups.
f. The function keys include the following four:
i. [symbol] : The key to indicate that the current keypad is using Zhu-Yin system. When clicked, the keypad will be changed to Pin-Yin mode.
ii. [symbol] : This button indicates that the text exported from the system will be in Unicode codes. When clicked, the text exported will change to use other coding schemes.
iii. [symbol] : A button to select between the Automatic-Firing and the Manual-Control key-in mode. When in the Automatic-Firing mode, the focusing point in a sentence editing buffer will advance to the next word automatically once the mouse button has been released on a key. When in Manual-Control mode, the focusing point will be manually changed by the user.
iv. [symbol] : A simple editing button to erase the phonetic symbol string of the current word.

3. The method of claim 1, wherein said R-1 refining control window panel contains a label and an associated subset of the H-set. The label and the subset of the H-set are defined as follows.
a. The label must be a symbol in the C-set. The subset associated with the label is the set of all the H symbols that can follow the label symbol in a valid Zhu-Yin symbol string.
b. If the label is the blank symbol [symbol] , the subset is the set of all the H symbols that is the starting symbol of a valid Zhu-Yin symbol string, which is exactly the H-set.

4. The method of claim 1, wherein said R-2 refining control window panel contains a set of keys of the V-set. An R-2 panel will pop up on the screen when a key in an R-1 panel has been selected. Therefore, every R-2 panel is associated with the label of an R-1 panel and an H symbol in the panel. A subset of the keys in R-2 is activated and the remaining keys are de-activated. A key in R-2 is activated if its symbol can follow the associated label symbol and the selected H symbol in R-1 in a valid Zhu-Yin symbol string. The allocation of the V-set keys is kept the same as the V-set keys in the Zhu-Yin Keypad to reduce flickering effect.

5. The method of claim 1, wherein said Press-Touch-Release (PTR) sequence of mouse operation is performed to select the C, H, and V components of a Zhu-Yin phonetic symbol string according to the following rules.
a. The user presses a first key in the Zhu-Yin Keypad to select a C component as well as launch an associated R-1 panel.
b. The user moves the cursor to touch a key in the R-1 panel to select an H symbol as well as launch an associated R-2 panel.
c. The user releases the mouse button with the cursor on an activated key in R-2 to select the V component.
d. Depending on the phonetic symbols selected in step a and step b, blank symbols may be determined to fill in for the C or H components.
e. At the instant when the user releases the mouse button with the cursor on a key, the selected Zhu-Yin symbol string is entered into the computer.
f. The user may release the mouse button after pressing a key in step a or after the touching of the cursor with a key in step b to interrupt the PTR operation and enter the intermediate result, which is always a leading string of a complete valid Zhu-Yin symbol string.
g. Means can be implemented to allow the user to retract from each of the previous mouse action.

6. A Pin-Yin input method to input Pin-Yin phonetic symbol string into a computer, said method consists of a Pin -Yin Keypad, an R-1 refining control window panel, and an R-2 refining control panel. A sequence of mouse operations called Press-Touch-Release (PTR) operation is designed on the Pin-Yin Keyboard and the R-1 and R-2 panels to enter valid phonetic symbol strings of the Pin -Yin system.

7. The method of claim 6, wherein said Pin-Yin Keypad contains 26 alphabet keys, from A to Z, five tonal keys { [symbol] }, and several function keys.
a. The 26 alphabet keys are gathered into eight groups as [ABCD, EFG, HIJ, KLMN, OPQ, RST, UVW, XYZ].
b. The eight groups above are arranged in the alphabetical order and placed from left to right, top to bottom onto the keypad with spaces between neighboring groups.
c. The 5 T-set keys [ [symbol] ] are arranged in a row or in two columns and placed below the alphabet key groups to facilitate mouse operations.
d. The keys within each alphabet key group and the tonal key group are arranged in the standard Pin-Yin symbol order inside the group. Spaces have been reserved between neighboring groups.
e. The function keys include the following five:
i. [symbol] : The key to indicate that the current keypad is using Pin -Yin system. When clicked, the keypad will be changed to Zhu -Yin mode.
ii. [symbol] : This button indicates that the text exported from the system will be in Unicode codes. When clicked, the text exported will change to use other coding schemes
iii. [symbol] : A button to select between the Automatic-Firing and the Manual-Control key-in mode.
iv. [symbol] : A simple editing button to erase the phonetic symbol string of the current word.
v. [symbol] : A button used to end the typing of the Pin-Yin phonetic symbol string of the current word when the system is using Pin-Yin phonetic system and in Manual-Control key-in mode.

8. The method of claim 6, wherein a said R-1 refining control window panel contains a label and a set of keys associated with the label string. The label and the corresponding set of keys are defined as follows.
a. The label is a string of the first string (ζ-) set of {A, B, C, CH, D, E, F, G, H, JI, JU, K, L, M, N, O, P, QI, QU, R, S, SH, T, W, X, XU, Y, Z, ZH}.
b. Associated with each first string is a set of second string (σ-), which is the set of symbols that can follow the first string in a valid symbol string of the Pin-Yin phonetic system.

9. The method of claim 6, wherein said R-2 refining control window panel contains a set of keys. An R-2 panel will pop up on the screen when a key in an R-1 panel has been selected. Therefore, an R-2 panel is associated with the label string and a ζ key symbol of an R-1 panel. A key is created in R-2 for each phonetic symbol string that can follow the associated first (ζ-) string and the second (σ-) string in a valid phonetic string in the Pin-Yin system. The set of strings of the keys in the R-2 panel is called the set of the third string (τ-).

10. The method of claim 6, wherein said Press-Touch-Release (PTR) sequence of mouse operations is performed to select the ζ, σ, and τ components of the Pin-Yin phonetic symbol string according to the following rules.
a. The user presses a key in the Pin -Yin Keypad to select the ζ string as well as launch an associated R-1 panel. A ζ string is selected if its leading symbol is the key symbol selected. In case that two ζ components having the same leading key symbol, one of the R-1 panel will be placed at the top of the Pin -Yin Keypad while other R-1 panel will be placed at the bottom. There can be at most two ζ strings containing the same heading symbol.
b. The user moves the cursor to touch a key in the R-1 panel to select an σ string (symbol) as well as launch an associated R-2 panel.
c. The user releases the mouse button with the cursor on a key in R-2 to select the τ component.
d. At the instant when the user releases the mouse button the selected Pin-Yin symbol string (ζ σ τ) is entered into the computer.
e. The user may release the mouse button after pressing a key in step a or after the touching of the cursor with a key in step b to interrupt the PTR operation and enter a leading string of a complete valid Pin-Yin symbol string.
f. Means can be implemented to allow the user to retract from each of the previous mouse action.

11. A cascade Multi-Window contains several over-lapped window pages with the following properties:
a. The window pages are rectangular and are of the same size.
b. The window pages are arranged in a cascade going from the lower-left position to the higher-right position in the Multi-Window.
c. At any time one of the pages in the Multi-Window is the topmost page on the screen.
d. Every window page in the Multi-Window has an exposed region on the screen. Pages lower than the topmost page show an L-shaped region on the screen. Pages higher than the topmost page show an inversed L-shaped region on the screen. These L-shaped and inversed L-shaped regions surround the topmost page on the screen. This relationship will be maintained when a page is brought to be the topmost page of the Multi-Window.
e. When the mouse is moved onto the exposed region of a page in the Multi-Window, that page will be brought to the top of the Multi-Window, and becomes the topmost page on the screen. This allows the user to browse the pages sequentially in both the ascending and descending directions of the cascade Multi-Window without mouse clicking operations.
f. The pages in the Multi-Window may contain buttons to display Chinese words, phrases and punctuation symbols. A user may browse within a page among these buttons. A word, a phrase, or a punctuation symbol will be selected by the mouse button-up event.
g. A word, a phrase, or a punctuation symbol selected from a page in the Multi-Window will flow to the Sentence Editing Buffer, and be appended at the end of the current sentence that is being composed in the Sentence Editing Buffer. It will also flow to an application program if the valve between the Multi-Window and the application program is open.

12. A platform to implement a Chinese input method, said platform consists of the following components:
A Keypad of claim 1 or claim 6, a cascade Multi-Window of claim 11, a Sentence Editing Buffer, an Attribute Viewing Window, and a Text Accumulation Window.

13. The platform of claim 12, wherein said Sentence Editing Buffer is a window containing a fixed number of keys (buttons). These keys are places to show the words of a sentence. A sentence being composed will be shown in the Sentence Editing Buffer. The key of a word will show the character if it is
b. From the Keypad to the R-1 refining control panel.
c. From the R-1 refining control panel to the cascade Multi-Window.
d. From the R-1 refining control panel to the R-2 refining control panel.
e. From the R-2 refining control panel to the cascade Multi-Window.

[symbol]

17. The platform of claim 12, wherein said platform provides a user the following data flow paths between the windows:
a. From the Keypad to the Sentence Editing Buffer.
b. From the cascade Multi-Window to the Sentence Editing Buffer.
c. From the Sentence Editing Buffer to the text accumulation window.

18. The platform of claim 12, wherein said platform provides a user the following data flow control valves between the internal windows to an external application program:
a. From the cascade Multi-Window to an external application program.
b. From the Sentence Editing Buffer to an external application program.
c. From the Text Accumulation Window to an external application program.

19. A Chinese input method implemented on the platform of claim 12, said method has the following properties:
a. A user uses a two-phase procedure to generate sentences. The procedure consists of a key-in phase and an editing phase.
b. In the key-in phase, a user may select words or phrases from the cascade Multi-Window in sequence to compose a sentence. He may also use the Keypad to key-in phonetic symbol strings to specify the words or phrases instead.
c. In the editing phase, helped by the system, the user will scan from left to right to find the places where character information has not yet been chosen and then fill in actual words by selecting words or phrases from the cascade Multi-Window.
d. A frequency-based multi-level strategy is used by the system to classify phrases to present to the user in the cascade Multi-Window. Different phrase sets are shown in the Multi-Window at different stages in the Two-Phase Sentence Generation Procedure.
e. The phrases are classified into four classes: the most-frequently used, very-frequently used, commonly used, and rarely used. Rarely used phrases are accessible explicitly via a button in the phrase presentation.
f. A user can get a most-frequently used phrase from the Multi-Window without performing any mouse activities in the Keypad.
g. The very frequently used phrases are associated with the phonetic symbols of the phonetic system. The association can be practiced by partitioning the phrases according to the first symbols of the phonetic symbol strings of the first word of the phrases. A user may select a very frequently used phrase set by press on the associated key.

20. The method of claim 10, wherein said key-in phase of the Two-Phase Sentence Generation Procedure has the following operations and properties:
a. A user either selects words or phrases from the cascade Multi-Window or key-in phonetic symbol strings as the attributes of the phrase words to compose a sentence.
b. The symbol string keyed in can be either a complete phonetic symbol string, including the tonal symbol, or a leading portion of the complete string.
c. The user can elect to use either the Manual-Control Mode or the Automatic-Firing Mode to control the word of focusing in the Sentence Editing Buffer. In the Manual-Control Mode, the user controls the focus location manually. In the Automatic-Firing Mode, the system advances the focus to the next word automatically when the user releases the mouse button in a PTR operation for the current word.
d. The user can go to the Multi-Window to select a word to specify the matching condition for a phrase.
